(19) United States
(12) Patent Application Publication
(10) Pub. No.: US 2025/0332738 A1
(43) Pub. Date: Oct. 30, 2025

(54) MODULAR ROBOT APPARATUS USING CONCENTRIC DIRECT DRIVE MOTORS

(71) Applicant: n&k Technology, Inc., San Jose, CA (US)

(72) Inventors: Samuel BUNK, San Jose, CA (US); Alvin MANINGDING, San Jose, CA (US)

(21) Appl. No.: 18/887,831

(22) Filed: Sep. 17, 2024

Related U.S. Application Data
(60) Provisional application No. 63/639,504, filed on Apr. 26, 2024.

(51) Int. Cl. B25J 15/04; B25J 9/00; B25J 9/08; B25J 11/00; B25J 15/06; B25J 19/00

(52) U.S. Cl. CPC B25J 15/04; B25J 9/0081; B25J 9/08; B25J 11/0095; B25J 15/0616; B25J 19/0029

(57) ABSTRACT

Described are modular robot apparatuses for transferring samples. An apparatus can include a Z module configured to transfer the sample along a vertical axis; a motor module operatively coupled to the Z module and configured to independently operate one or more arms of the apparatus; an arm module comprising the one or more arms operatively coupled to the motor module and configured to transfer the sample along one or more horizontal axes orthogonal to the vertical axis; one or more interchangeable end effectors operatively coupled to the arm module and configured to releasably hold the sample; and a controller module configured to control the Z module, the motor module, the arm module, and the one or more interchangeable end effectors for transferring the sample.

### CROSS REFERENCE TO RELATED APPLICATIONS

The present application claims the benefit of U.S. Provisional Application No. 63/639,504, filed Apr. 26, 2024, which is incorporated by reference herein in its entirety.

### BACKGROUND

The global supply chain has encountered significant technical problems over the past few years. For example, parts for a complex robot in semiconductor manufacturing may become unavailable thereby rendering the robot inoperative. Designing and constructing a modular robot with distinct and interchangeable modules can allow for easier design changes to accommodate part shortages as they arise. A modular design can be useful when the robot includes long lead time parts for replacement. For example, the robot may be designed and constructed with direct drive motors associated with long lead times to source and replace. A modular design can also be useful to streamline the process of installation and integration between different system types in semiconductor manufacturing. Unfortunately, designing and constructing a robot in a modular way can increase the size or footprint of the robot, which may not be practical in space-confined areas of the semiconductor industry.

Accordingly, there is a need for a modular robot that can overcome these technical challenges while maintaining a small size or footprint.

### SUMMARY

The present disclosures provides a modular robot for selective compliance assembly robot arms (SCARA) to help overcome these technical problems. For example, the modular robot can be a 4-axis modular robot designed and constructed for transferring different samples, e.g., wafers or photomasks, within metrology systems for the semiconductor industry. The modular robot can be configured to independently control each arm joint (e.g., a 3-arm joint arm module) to handle all movements in space-confined areas of semiconductor manufacturing. The modular robot can be configured to accept different interchangeable end effectors depending on the sample. The modular robot can be configured to localize all arm motors (e.g., direct drive motors) within a central core of the modular robot thereby minimizing the size or footprint of the modular robot. At least the combination of this smaller footprint and the ability to be configured for different samples can allow for improved flexibility in installation and can improve or overcome the technical problems of the supply chain.

In an aspect, disclosed herein is an apparatus for transferring a sample, the apparatus comprising: a Z module configured to transfer the sample along a vertical axis; a motor module operatively coupled to the Z module and configured to independently operate one or more arms of the apparatus; an arm module comprising the one or more arms operatively coupled to the motor module and configured to transfer the sample along one or more horizontal axes orthogonal to the vertical axis; one or more interchangeable end effectors operatively coupled to the arm module and configured to releasably hold the sample; and a controller module configured to control the Z module, the motor module, the arm module, and the one or more interchangeable end effectors for transferring the sample, wherein the Z module, the motor module, or the arm module is configured to be interchangeable with another module.

In some embodiments, the Z module further comprises: a motor; a ball screw operatively coupled to the motor; a rail and carriage operatively coupled to the ball screw via a nut; and a platform configured to mount the motor module, wherein collective operation of the motor, the ball screw, the rail and carriage, and the nut by the Z module is configured to transfer the sample along the vertical axis.

In some embodiments, the motor module further comprises: a first direct drive motor configured to operate the one or more arms; a second direct drive motor configured to operate the one or more arms; and a third direct drive motor configured to operate the one or more arms, wherein collective operation of the first, the second, and the third direct drive motors is configured to transfer the sample along any axis of the one or more horizontal axes. In some embodiments, each of the first, the second, and the third direct drive motors is positioned in a central portion of a frame of the apparatus. In some embodiments, each of the first, the second, and the third direct drive motors is arranged concentrically with each of the other direct drive motors. In some embodiments, each of the first, the second, and the third direct drive motors is arranged above or below each of the other direct drive motors.

In some embodiments, the motor module further comprises: a first shaft operatively coupled to and concentrically aligned inside the first direct drive motor and configured to transmit a mechanical force to the one or more arms via one or more cross roller bearings; a second shaft operatively coupled to and concentrically aligned inside of the second direct drive motor and configured to transmit a mechanical force to the one or more arms arm via one or more pulleys and one or more timing belts; and a third shaft operatively coupled to and concentrically aligned inside of the third direct drive motor and configured to transmit a mechanical force to the one or more arms arm via one or more pulleys and one or more timing belts, wherein collective operation of the first, the second, and the third shafts by the motor module is configured to transfer the sample along any axis of the one or more horizontal axes. In some embodiments, the second shaft is concentrically aligned inside the first shaft and wherein the third shaft is concentrically aligned inside the second shaft.

In some embodiments, the motor module further comprises a conduit configured to: carry one or more control signal wires from the controller module to the arm module or the motor module; and carry a vacuum line from a vacuum source to the one or more interchangeable end effectors via the arm module. In some embodiments, the conduit is concentrically aligned inside of the third shaft and is attached to a first arm of the one or more arms. In some embodiments, the motor module is controlled by the controller module to collectively operate the first, the second, and the third direct drive motors to effect transferring the sample along a learned motion path between one or more learned positions.

In some embodiments, the arm module further comprises: a first arm of the one or more arms operatively coupled to a first cross roller bearing of the motor module and configured with a second cross roller bearing associated with a first set of one or more shafts, one or more pulleys, one or more timing belts, one or more concentric steel plates, or one or more stops; a second arm of the one or more arms operatively coupled to the second cross roller bearing of the first arm and configured with a third cross roller bearing associated with a second set of one or more shafts, one or more pulleys, one or more timing belts, one or more concentric steel plates, or one or more stops; and a third arm of the one or more arms operatively coupled to the third cross roller bearing of the second arm, wherein the third arm is configured to releasably hold the one or more interchangeable end effectors, wherein collective operation of the first, the second, and the third arms by the arm module is configured to transfer the sample along any axis of the one or more horizontal axes. In some embodiments, each of the one or more arms of the arm module do not comprise an integrated motor. In some embodiments, each of the one or more arms of the arm module comprises a three-joint arm module.

In some embodiments, the one or more interchangeable end effectors comprises a first end effector configured to releasably hold a wafer. In some embodiments, the first end effector is further configured to: operatively couple to a vacuum for releasably holding the wafer; and operatively couple to a sensor for determining a presence of the wafer, wherein the sensor comprises a vacuum sensor. In some embodiments, the one or more interchangeable end effectors comprises a second end effector configured to releasably hold a photomask. In some embodiments, the second end effector is further configured to: operatively use one or more pads for contacting the photomask along one or more edges of the photomask; and operatively couple to a sensor for determining a presence of the photomask, wherein the sensor comprises a limited reflected fiber unit.

In some embodiments, the controller module further comprises: a power module configured to supply power for operating the apparatus; a communications module configured to generate control signals for operating the apparatus; a motor controller module configured to control the motor module or the motor of the Z module; and a software module configured to provide power signals, communication signals, or control signals to collectively operate the apparatus.

In some embodiments, the software module is further configured to provide training of the apparatus, wherein the training comprises generating one or more learned positions of the apparatus and generating one or more learned motion paths of the apparatus between the one or more learned positions. In some embodiments, the software module is further configured to determine or affect a change in an orientation of the sample, based at least on the one or more learned positions or the one or more learned motion paths, wherein the change in orientation comprises a smooth change between one or more intermediate orientations to the orientation of the sample. In some embodiments, the software module is further configured to provide troubleshooting of the apparatus, wherein the troubleshooting comprises testing functionality of the Z module, testing functionality of the motor module, testing functionality of the arm module, brake toggling, toggling of one or more peripherals, displaying the one or more learned positions, displaying the one or more learned motion paths, or moving the apparatus between any learned positions by any learned motion paths. In some embodiments, the software module is further configured to execute a wafer mapping function comprising: positioning a wafer presence scanner proximate to a wafer cassette; scanning along one or more dimensions of the wafer cassette; detecting a presence of one or more wafers in the wafer cassette; and determining one or more problems associated with the one or more wafers, wherein the one or more problems comprises (i) one of the wafers oriented at an incorrect angle relative to a wafer slot of the wafer cassette, (ii) two or more wafers occupying the wafer slot, or (iii) any combination of (i) or (ii), wherein the one or more end interchangeable effectors comprises the wafer presence scanner. In some embodiments, the software module comprises a virtual joystick and graphical user interface (GUI) configured to allow a user to manually control the apparatus to one or more positions along one or more motion paths. In some embodiments, the one or more motion paths comprise (i) one or more arbitrary motion paths, (ii) the one or more learned motion paths, or (iii) a combination of (i) or (ii)

In some embodiments, the apparatus is configured to rotate the sample relative to the apparatus during transferring of the sample or during a stationary position of the sample. In some embodiments, the apparatus is configured to maintain a fixed orientation of the sample relative to the apparatus during transferring of the sample or during a stationary position of the sample to avoid one or more collisions of the sample. In some embodiments, the vertical axis and the one or more horizontal axes are not aligned to the center of the apparatus.

In some embodiments, the apparatus further comprises: a first frame configured to enclose the Z module and the motor module in a central portion of the first frame; a second frame configured to mount the controller module to the apparatus, wherein the second frame comprises a sheet metal box for enclosing the controller module; and one or more covers for the first and second frames configured to provide safe operation for a user.

In some embodiments, the Z module, the motor module, or the arm module is configured to be interchangeable with another module of the same type. In some embodiments, the apparatus comprises a 4-axis modular robot.

Additional aspects and advantages of the present disclosure will become readily apparent from the following detailed description, wherein only illustrative embodiments of the present disclosure are shown and described. As will be realized, the present disclosure is capable of other and different embodiments, and its several details are capable of modifications in various obvious respects, all without departing from the present disclosure. Accordingly, the drawings and description are to be regarded as illustrative in nature and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the present disclosure contained in the specification, the specification is intended to supersede and/or take precedence over any such contradictory material.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, in which the principles of the present disclosure are utilized, and the accompanying drawings of which:

FIGS. 1A-1B illustrate the robot apparatus in different configurations in accordance with some embodiments; FIG. 1A illustrates a perspective view of the robot apparatus configured for transferring a sample, e.g., a wafer, which can include certain features described herein; FIG. 1B illustrates a perspective view of the robot apparatus configured for transferring a sample, e.g., a photomask, which can include certain features described herein;

FIGS. 2A-2D illustrate the controller module of the robot apparatus, in accordance with some embodiments. FIG. 2A illustrates a perspective view of the controller module with panels or covers, which can include certain features described herein; FIG. 2B illustrates a perspective view of the controller module without panels or covers, which can include certain features described herein; FIG. 2C illustrates a plan view (top view) of the controller module without panels or covers, which can include certain features described herein; FIG. 2D illustrates a plan view (front view) of the controller module without panels or covers, which can include certain features described herein;

FIGS. 3A-3G illustrate the Z module of the robot apparatus, in accordance with some embodiments; FIG. 3A illustrates a perspective view of the Z module with panels or covers, which can include certain features described herein; FIG. 3B illustrates a perspective view of the Z module without panels or covers, which can include certain features described herein; FIG. 3C illustrates a perspective view of the Z module without panels or covers, front plate, or energy chain tray, which can include certain features described herein; FIG. 3D illustrates a plan view (side view) of the Z module without panels or covers, front plate, or energy chain tray, which can include certain features described herein; FIG. 3E illustrates a plan view (front view) of the Z module without panels or covers, front plate, or energy chain tray, which can include certain features described herein; FIG. 3F illustrates a perspective view of the Z module, which can include a carriage assembly and certain features thereof described herein; FIG. 3G illustrates a perspective view of the Z module, which can include a carriage assembly (mounting platform not shown) and certain features thereof described herein;

FIGS. 4A-4I illustrate the motor module of the robot apparatus, in accordance with some embodiments; FIG. 4A illustrates a perspective view of the motor module with panels or covers, which can include certain features described herein; FIG. 4B illustrates a perspective view of the motor module without panels or covers, which can include certain features described herein; FIG. 4C illustrates a plan view (section view) of the motor module without panels or covers, which can include certain features described herein; FIG. 4D illustrates a plan view (section view) of the motor module, which can include one or more motors (e.g., a direct drive motor) and certain features thereof described herein; FIG. 4E illustrates a plan view (section view) of the motor module, which can include one or more motors (e.g., a direct drive motor) and certain features thereof described herein; FIG. 4F illustrates a plan view (section view) of the motor module, which can include one or more motors (e.g., a direct drive motor) and certain features thereof described herein; FIG. 4G illustrates a plan view (section view) of the motor module, which can include one or more motors (e.g., a direct drive motor) and certain features thereof described herein; FIG. 4H illustrates a plan view (section view) of the motor module, which can include one or more motors (e.g., direct drive motors) and certain features thereof described herein; FIG. 4I illustrates a plan view (section view) of the motor module, which can include one or more motors (e.g., a direct drive motor) and certain features thereof described herein;

FIGS. 5A-5H illustrate the arm module of the robot apparatus, in accordance with some embodiments; FIG. 5A illustrates a perspective view of the arm module configured for transferring a sample, e.g., a wafer, which can include certain features described herein; FIG. 5B illustrates a perspective view of the arm module configured for transferring a sample, e.g., a photomask, which can include certain features described herein; FIG. 5C illustrates a plan view (section view) of the arm module, e.g., a first arm, which can include certain features described herein; FIG. 5D illustrates a plan view (section view) of the arm module, e.g., a second arm, which can include certain features described herein; FIG. 5E illustrates a plan view (section view) of the arm module, e.g., a third arm, for transferring a sample, e.g., a wafer, which can include certain features described herein; FIG. 5F illustrates a plan view (section view) of the arm module, e.g., a third arm, for transferring a sample, e.g., a photomask, which can include certain features described herein; FIG. 5G illustrates a perspective view of the arm module, e.g., a third arm, for transferring a sample, e.g., a wafer, which can include certain features described herein; FIG. 5H illustrates a perspective view of the arm module, e.g., a third arm, for transferring a sample, e.g., a photomask, which can include certain features described herein;

FIGS. 6A-6B illustrate user interfaces for the robot apparatus, in accordance with some embodiments; FIG. 6A illustrates a user interface, e.g., a graphical user interface (GUI), for operating the robot apparatus; FIG. 6B illustrates a user interface, e.g., a graphical user interface (GUI), for training the robot apparatus;

FIG. 7 illustrates a non-limiting example of a computing device configured to perform systems and methods described herein, in accordance with some embodiments;

FIG. 8 illustrates a non-limiting example of a web or mobile application provision system configured to perform systems and methods described herein, in accordance with some embodiments; and

FIG. 9 illustrates a non-limiting example of a cloud-based web or mobile application provision system configured to perform systems and methods described herein, in accordance with some embodiments.

### DETAILED DESCRIPTION

While various embodiments of the present disclosure have been shown and described herein, such embodiments are provided by way of example only. Numerous variations, changes, or substitutions may occur without departing from the present disclosure. It should be understood that various alternatives to the embodiments of the present disclosure described herein may be employed.

### Introduction

In an aspect, disclosed herein is an apparatus 100 for transferring a sample. In some embodiments, the apparatus 100 comprises a Z module 300 configured to transfer the sample along a vertical axis. In some embodiments, the apparatus 100 comprises a motor module 400 operatively coupled to the Z module 300 and configured to independently operate one or more arms of the apparatus 100. In some embodiments, the apparatus 100 comprises an arm module 500 comprising the one or more arms operatively coupled to the motor module 400 and configured to transfer the sample along one or more horizontal axes orthogonal to the vertical axis. In some embodiments, the apparatus 100 comprises one or more interchangeable end effectors 700 or 800 operatively coupled to the arm module 500 and configured to releasably hold the sample. In some embodiments, the apparatus 100 comprises a controller module 200 configured to control the Z module 300, the motor module 400, the arm module 500, and the one or more interchangeable end effectors 700 or 800 for transferring the sample. In some embodiments, the apparatus 100 comprises the Z module 300, the motor module 400, or the arm module 500 is configured to be interchangeable with another module. In some embodiments, the apparatus 100 comprises a 4-axis modular robot. In some embodiments, the vertical axis and the one or more horizontal axes are not aligned to the center of the apparatus 100.

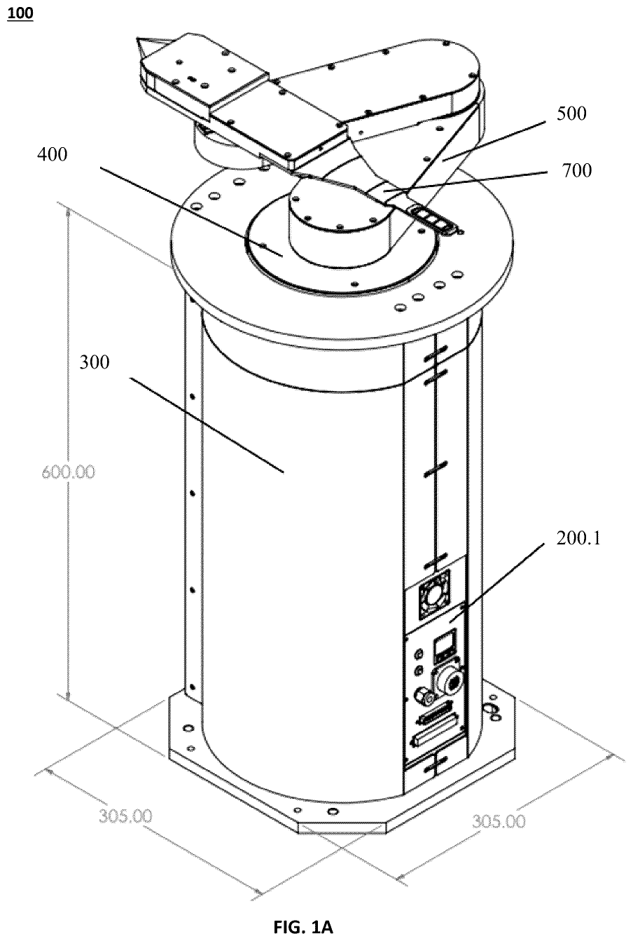

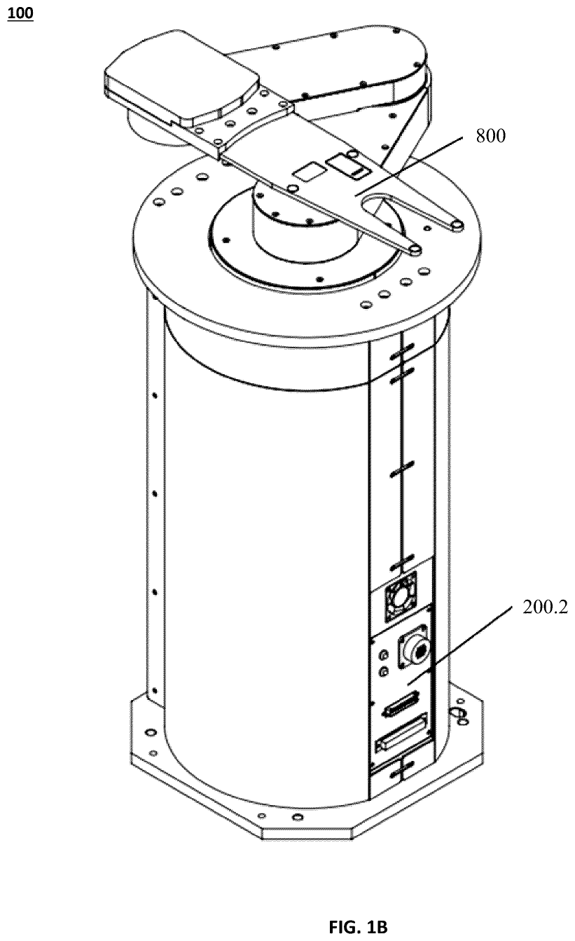

FIGS. 1A-1B illustrate the apparatus 100, which can include a Z module 300, a motor module 400, an arm module 500, one or interchangeable end effectors 700 or 800, or a controller module 200 (e.g., 200.1 or 200.2). In some embodiments, the Z module 300, the motor module 400, or the arm module 500 is configured to be interchangeable with another module of the same type. Each module is further described herein.

The modular robot apparatus 100 herein can be used in space-confined areas of the semiconductor industry. In some cases, the robot apparatus 100 herein can be configured to comply with selective compliance assembly robot arms (SCARA) of the serial type for the transfer of samples in semiconductor manufacturing, e.g., wafers, photomasks, and the like. In some cases, the robot apparatus 100 herein can be configured to automatically perform pick and place operations between different stations. In some cases, the stations can include cassettes, alignment stations, permanent storage areas, process stations, and the like. In some cases, the robot apparatus 100 herein can determine or generate learned positions for transferring samples along learned motion paths between the learned positions. For example, during operation, the robot apparatus 100 can be configured to automatically track positional and status information of samples and other devices configured to interact with the samples. In some cases, status information can include data or information such as: where the sample was previously stored, which stations the sample has already been placed at, a presence verification after each pick and place operation, and the like. In some cases, the robot apparatus 100 can be configured to perform operations quickly (e.g., speed of operations) and precisely (e.g., small tolerances) to meet or exceed industry norms or standards and to achieve a high system throughput. For example, the robot apparatus 100 herein can be configured to achieve a horizontal tolerance (e.g., along Cartesian coordinates X and Y) of at least about ±0.05 millimeters (mm). For example, the robot apparatus 100 herein can be configured to achieve a vertical tolerance (e.g., along Cartesian coordinate Z) of at least about ±0.01 mm. For example, the robot apparatus 100 herein can automatically determine a speed of operation depending on the sample. In some cases, the speed may be slower for operations configured for transferring a photomask than for operations configured for transferring a wafer.

The modular robot apparatus 100 herein can be configured with one or more interchangeable modules. The one or more modules can be manufactured independently, easily assembled, and interchangeable. The one or more interchangeable modules herein can include: a Z module 300, a motor module 400, an arm module 500, or a controller module 200. The one or more modules can be configured for independent articulation of the arm joints (e.g., 3 arm-joint) within the arm module 500. In some cases, the robot apparatus 100 herein can advantageously provide for articulation of the arm joints without using any motors within the arms of the arm module 500. Such articulation can be provided at least by a motor module 400, which can be configured with one or more motors (e.g., 3 direct drive motors along axis A 413, axis B 414, and axis C 415) to transfer power to the arms of the arm module 500. The one or more modules can include a Z module 300, which can be configured to (i) function as a frame for the robot apparatus 100 and (ii) facilitate vertical movement of the other modules, e.g., the motor module 400 or the arm module 500. The one or more modules can include a controller module 200, which can be configured with different connectors (e.g., power, signal, or communication connectors) or can be configured with power connect in the Z module 300. The controller module 200 can be configured to handle all electrical and processing requirements of the robot apparatus 100. In some cases, the controller module 200 is integrated into the robot apparatus 100. In some cases, the controller module 200 is external to the robot apparatus 100 but operatively coupled to the robot apparatus 100.

The robot apparatus 100 herein can be designed and constructed with a small size or footprint for space-confined areas in semiconductor manufacturing. For example, at least the design and construction of the motor module 400, with direct drive motors (along axis A 413, axis B 414, and axis C 415) of the same type and size, and centrally located within the robot apparatus 100 can provide for the small size or footprint. The apparatus 100 can be configured with a predetermined size to accommodate the small footprint of the apparatus 100. In some cases, as illustrated in FIGS. 1A-1B, the apparatus 100 can be sized with a width of about 300 millimeters (mm), a height of about 600 mm, and a depth of about 300 mm. In some cases, the apparatus 100 can be sized with a width of at least about 200 mm-250 mm, 250 mm-300 mm, 300 mm-350 mm, 350 mm-400 mm, or greater. In some cases, the apparatus 100 can be sized with a width of at most about 400 mm-350 mm, 350 mm-300 mm, 300 mm-250 mm, 250 mm-200 mm, or less. In some cases, the apparatus 100 can be sized with a height of at least about 500 mm-550 mm, 550 mm-600 mm, 600 mm-650 mm, 650 mm-700 mm, or greater. In some cases, the apparatus 100 can be sized with a height of at most about 700 mm-650 mm, 650 mm-600 mm, 600 mm-550 mm, 550 mm-500 mm, or less. In some cases, the apparatus 100 can be sized with a depth of at least about 200 mm-250 mm, 250 mm-300 mm, 300 mm-350 mm, 350 mm-400 mm, or greater. In some cases, the apparatus 100 can be sized with a depth of at least about 400 mm-350 mm, 350 mm-300 mm, 300 mm-250 mm, 250 mm-200 mm, or less.

The robot apparatus 100 herein can be designed and constructed to be versatile and compatible with different interchangeable end effectors 700 or 800 (or “end effectors”). For example, the end effectors can include end effectors 700 for wafer handling, photomask handling 800, or handling other samples in semiconductor manufacturing. In some cases, the robot apparatus 100 herein can be designed and constructed with motors to operate the end effectors 700 or 800 via one or more arms of the arm module 500. For example, the motors can include direct drive motors (e.g., 3 direct drive motors along axis A 413, axis B 414, and axis C 415) to independently control each arm joint of the one or more arms. The direct drive motors (along axis A 413, axis B 414, and axis C 415) can be configured to achieve a small size or footprint for space-confined areas in semiconductor manufacturing. For example, the motors can include motors (e.g., 1 motor) to independently control vertical operation of the one or more arms of the arm module 500. The motor can be configured to operate the one or more arms along Cartesian coordinates (e.g., Z coordinate). The motor can be configured to also achieve a small size or footprint. In some cases, the motors can include geared servo motors.

Two applications in semiconductor manufacturing can include wafer handling and photomask handling. In some cases, each application can have different technical requirements, e.g., permissible motions and associated peripheral stations. The robot apparatus 100 herein can meet or exceed the technical requirements of both wafer handling and photomask handling while maintaining the same or similar size or footprint of the robot apparatus 100. Peripheral stations can include: alignment stations, permanent storage stations, inspection stations, thermal desorber stations, thermal outgassing stations, and the like. In some cases, wafer handling may have less stringent requirements (e.g., learned positions, learned motion paths, footprint, and the like) than photomask handling. For example, the robot apparatus 100 herein can be configured for 3-axis control when flexibility in allowed positions or motion paths is permissible or desired. Wafer handling may be associated with many stations, e.g., alignment stations or permanent storage stations, in which case the robot apparatus 100 herein can meet or exceed the requirements for a smaller size or footprint than for photomask handling. For example, the robot apparatus 100 herein can be configured for 4-axis control when flexibility in allowed motions is impermissible. Photomask handling may have more stringent requirements (e.g., learned positions, learned motion paths, footprint, and the like) than wafer handling even though associated with less stations than wafer handling but can have a larger size or footprint than configured for wafer handling.

The robot apparatus 100 herein can include a controller module 200 with a robust software control package. The software can allow a user to train positions (e.g., learned positions) and to train movements (e.g., learned motion paths) as determined by the sample or stations. Sample dependent functionality can be easily integrated during installation in a semiconductor environment. Different installations can include: dicing tools, probing tools, polish tools, edge grinder tools, chemical mechanical planarization (CMP) tools, lithography tools, metrology tools, and the like. Easy integrations can be provided by connection points for sensors, vacuums, vacuum lines, and the like. In some cases, connection points can be configured for air or vacuum access for the interchangeable end effectors 700 or 800. Motion planning and kinematics (e.g., learned positions or learned motion paths) can be determined by the control software and provide for multiple types of movement such as theta, radial, Cartesian, or any combination thereof. For example, the control software can determine or provide forward kinematics and inverse kinematics. In some cases, forward kinematics can include proceeding from arm joint angles to a Cartesian position. In some cases, inverse kinematics can include proceeding from a Cartesian position to all possible arm joint angle solutions.

For example, algorithms for forward kinematics and inverse kinematics can allow for direct conversion between joint angles and Cartesian position and orientation of both the sample and any part of the robot apparatus 100. The algorithms can be configured to (i) determine all possible solutions if multiple solutions can be found, (ii) determine the solution closest to another given solution, or (iii) determine an error if infinite solutions are found. The motion planning algorithms can utilize both types of kinematics (e.g., forward and inverse kinematics) to generate various types of learned positions or planned motion paths.

In some cases, “modular robot apparatus,” “robot apparatus,” or “apparatus” can be used interchangeably. In some cases, “interchangeable end effector” and “end effector” can be used interchangeably.

### Z Module

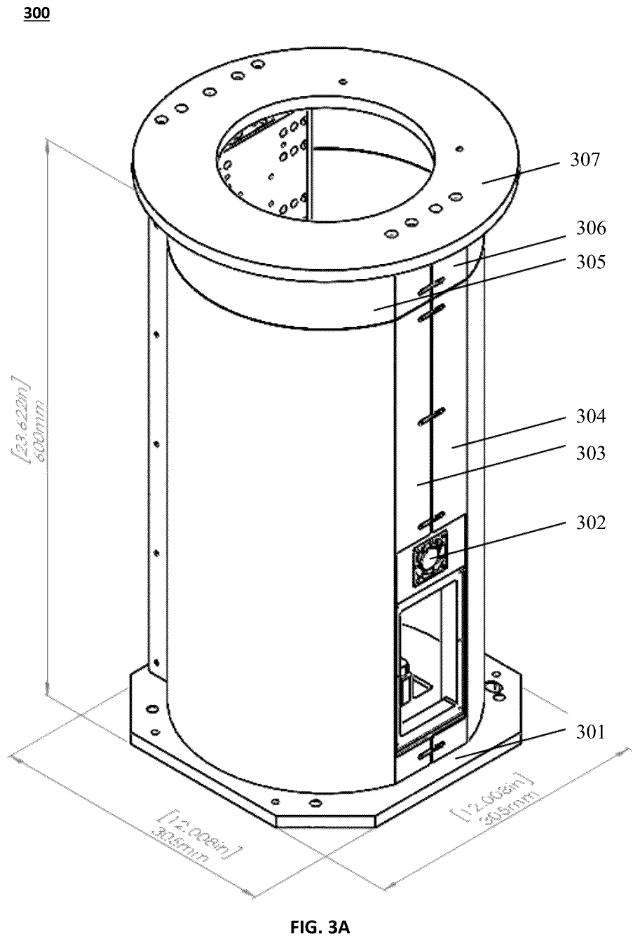

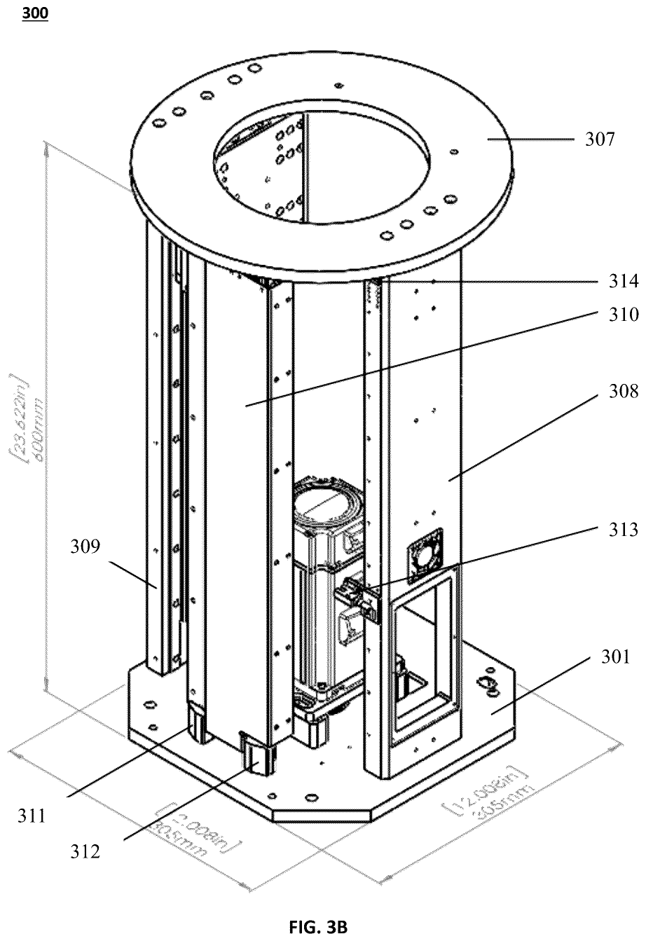

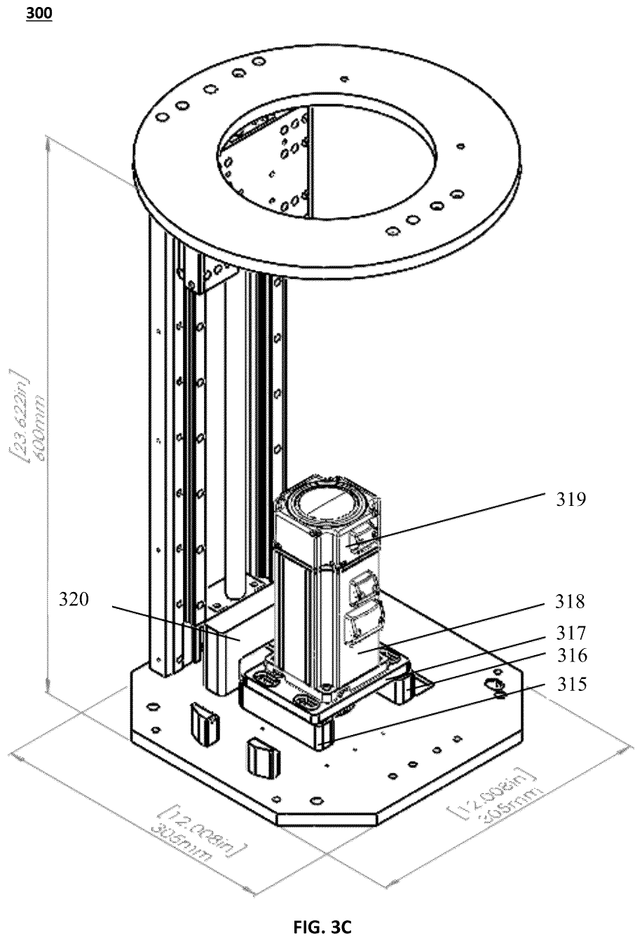

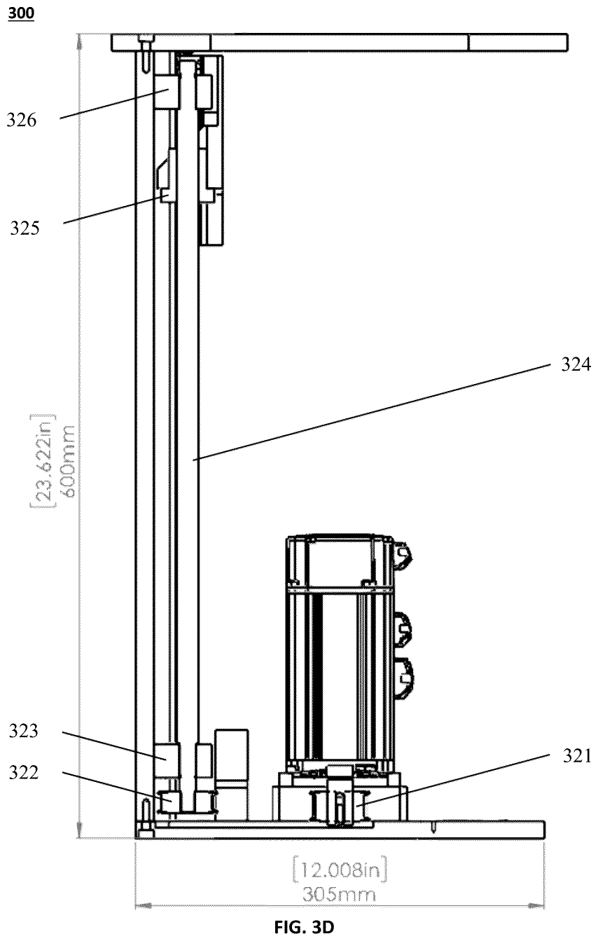

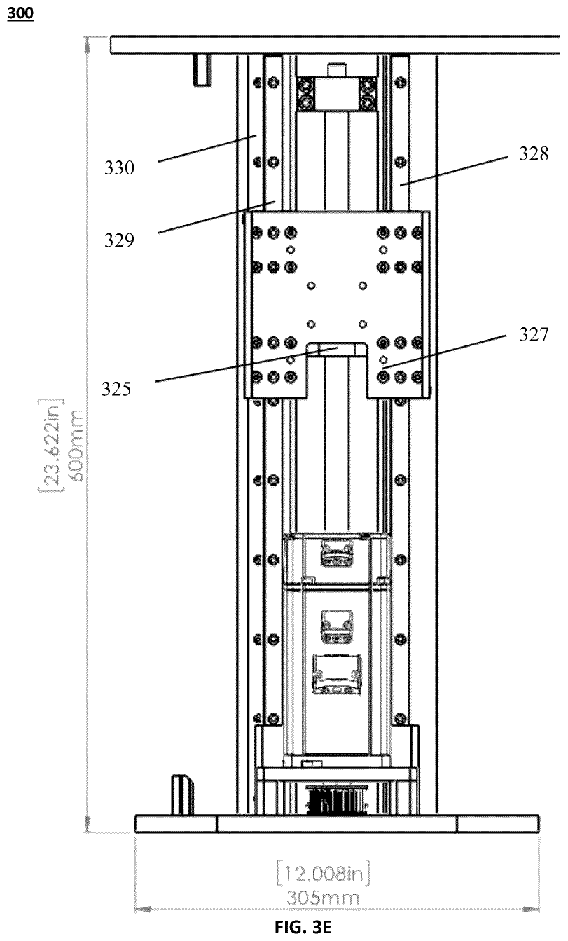

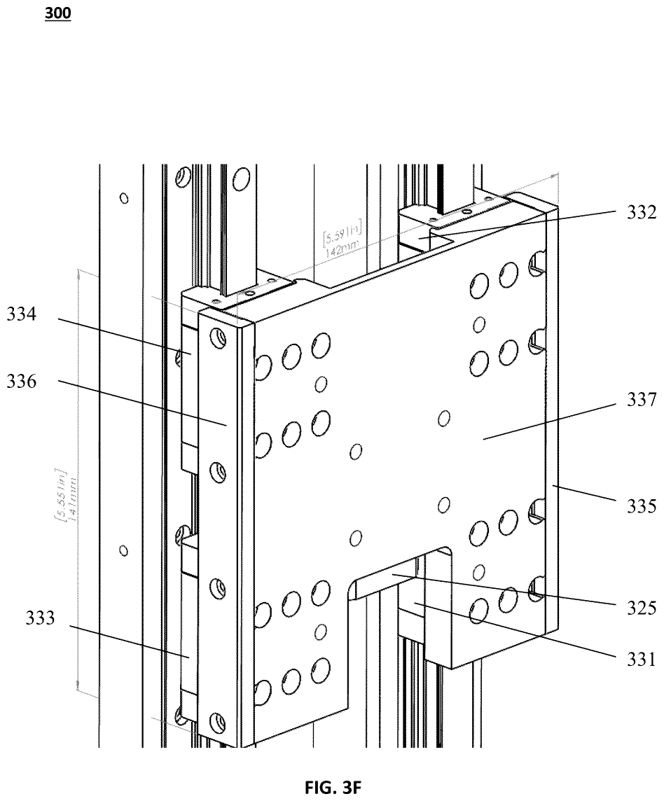

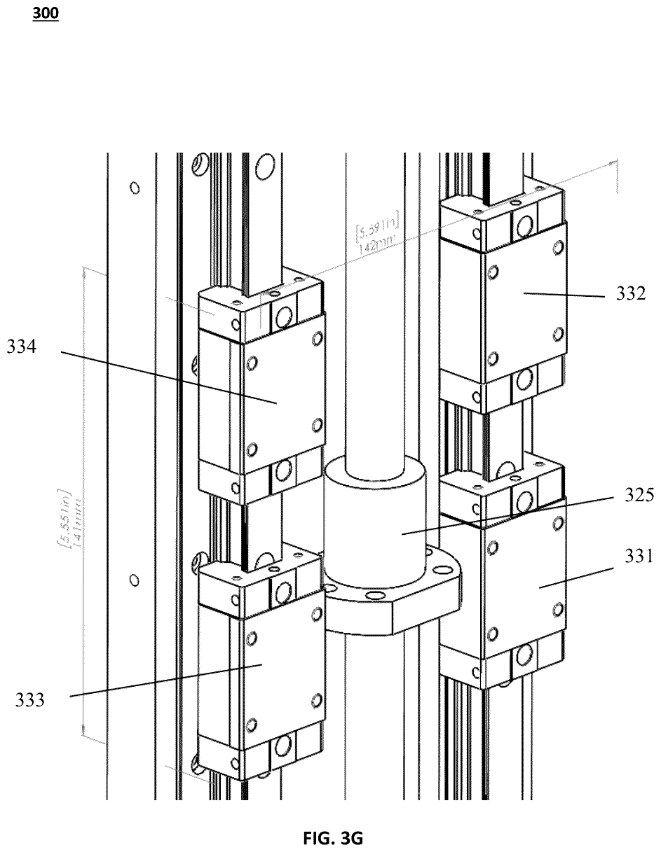

The robot apparatus 100 can be configured with a Z module 300. FIGS. 3A-3G illustrate the Z module 300 of the apparatus 100, which can be configured to control or affect operations during transferring of the sample. FIG. 3A illustrates a perspective view of the Z module 300, which can be configured to include: a base plate 301; one or more fans 302; one or more covers 303, 304, 305, and 306; or a top plate 307. FIG. 3B illustrates a perspective view of the Z module 300, which can be configured to include: one or more front plates 308; one or more back plates 309; an energy chain tray 310; one or more left tray pivots 311; one or more right tray pivots 312; one or more lower Z limit switches 313; or one or more upper Z limit switches 314. FIG. 3C illustrates a perspective view of the Z module 300, which can be configured to include: one or more Z motor spacers #1 315; one or more Z motor spacer #2 316; one or more Z motor mounting brackets 317; a Z motor 318; one or more power-off brakes 319; or one or more Z low hard stops 320. FIG. 3D illustrates a plan view (side view) of the Z module 300, which can be configured to include: one or more Z motor pulleys 321; one or more ball screw pulleys 322; one or more lower pillow blocks 323; one or more ball screws 324; one or more ball screw nuts 325; or one or more upper pillow blocks 326. FIG. 3E illustrates a plan view (front view) of the Z module 300, which can be configured to include: a carriage assembly 327; a right rail 328; a left rail 329; or one or more left rail mounting wedges 330. FIG. 3F illustrates a perspective view of the Z module 300, which can be configured to include: a lower right carriage 331; an upper right carriage 332; a lower left carriage 333; an upper left carriage 334; one or more right carriage clamps 335; one or more left carriage clamps 336; or a Z carriage mounting platform 337 configured to mount the motor module 400. FIG. 3G illustrates a perspective view of the Z module 300, which can be configured to include: the one or more ball screw nuts 325; the lower right carriage 331; the upper right carriage 332; the lower left carriage 333; or the upper left carriage 334.

The Z module 300 can be configured with a predetermined size to accommodate the small footprint of the apparatus 100. In some cases, as illustrated in FIGS. 3A-3G, the Z module 300 can be sized with a width of about 300 millimeters (mm), a height of about 600 mm, and a depth of about 300 mm. In some cases, the Z module 300 can be sized with a width of at least about 200 mm-250 mm, 250 mm-300 mm, 300 mm-350 mm, 350 mm-400 mm, or greater. In some cases, the Z module 300 can be sized with a width of at most about 400 mm-350 mm, 350 mm-300 mm, 300 mm-250 mm, 250 mm-200 mm, or less. In some cases, the Z module 300 can be sized with a height of at least about 500 mm-550 mm, 550 mm-600 mm, 600 mm-650 mm, 650 mm-700 mm, or greater. In some cases, the Z module 300 can be sized with a height of at most about 700 mm-650 mm, 650 mm-600 mm, 600 mm-550 mm, 550 mm-500 mm, or less. In some cases, the Z module 300 can be sized with a depth of at least about 200 mm-250 mm, 250 mm-300 mm, 300 mm-350 mm, 350 mm-400 mm, or greater. In some cases, the Z module 300 can be sized with a depth of at least about 400 mm-350 mm, 350 mm-300 mm, 300 mm-250 mm, 250 mm-200 mm, or less.

In some cases, the Z module 300 can be configured with a vertically mounted rail and carriage system within a frame. In some cases, movement of the Z module 300 along a vertical direction and control of the Z module 300 can be achieved through rotation of a ball screw whose nut is secured to the carriage system. In some cases, the ball screw can be powered by a motor to which it is coupled by use of a timing pulley. In some cases, movement of the Z module 300 can be limited through one or more hard stops and one or more optical limit switches, physical limit switches, or magnetic limit switches. In some cases, a horizontal platform can be attached to the carriage system for subsequent mounting of the motor module 400. In some cases, the Z module 300 can be configured with an energy chain for safe wire routing as well as for all connectors for linking the robot apparatus 100 to the controller module 200. In some cases, the Z module 300 can include one or more removable panels or covers to enclose the Z module 300.

In some embodiments, the Z module 300 further comprises a motor. In some embodiments, the Z module 300 further comprises a ball screw operatively coupled to the motor. In some embodiments, the Z module 300 further comprises a rail and carriage operatively coupled to the ball screw via a nut. In some embodiments, the Z module 300 further comprises a platform configured to mount the motor module 400. In some embodiments, the Z module 300 further comprises collective operation of the motor, the ball screw, the rail and carriage, and the nut by the Z module 300 is configured to transfer the sample along the vertical axis.

### Motor Module

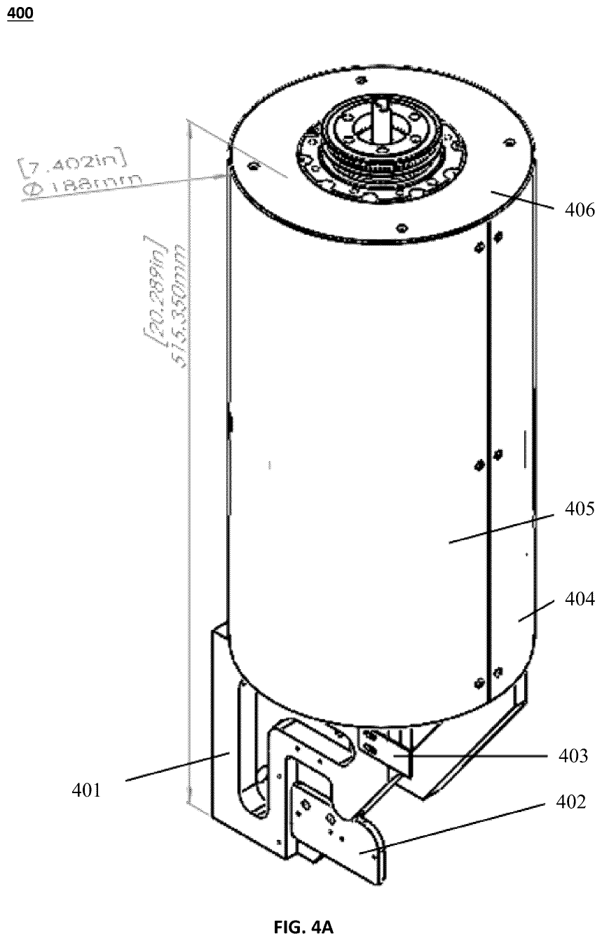

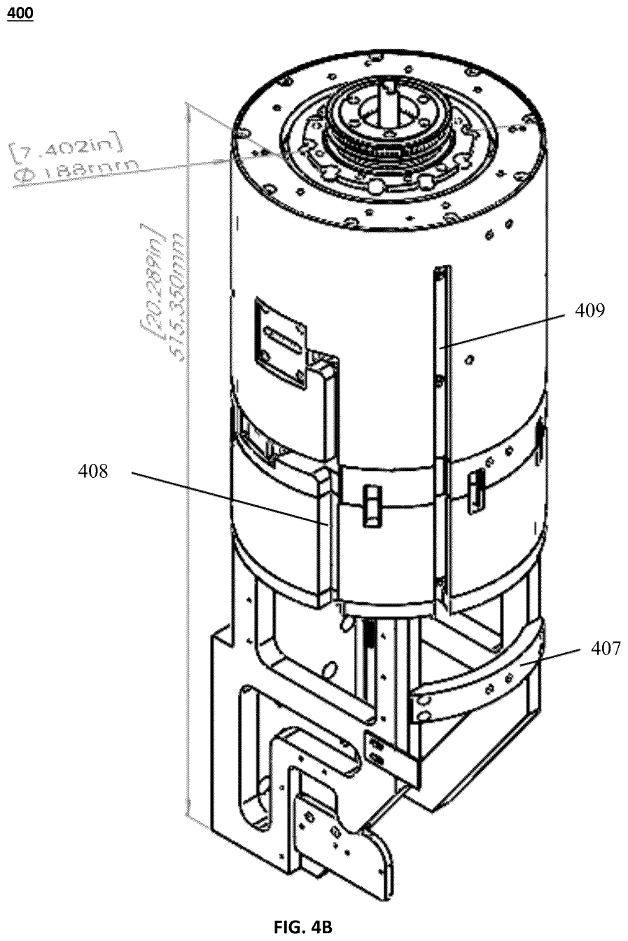

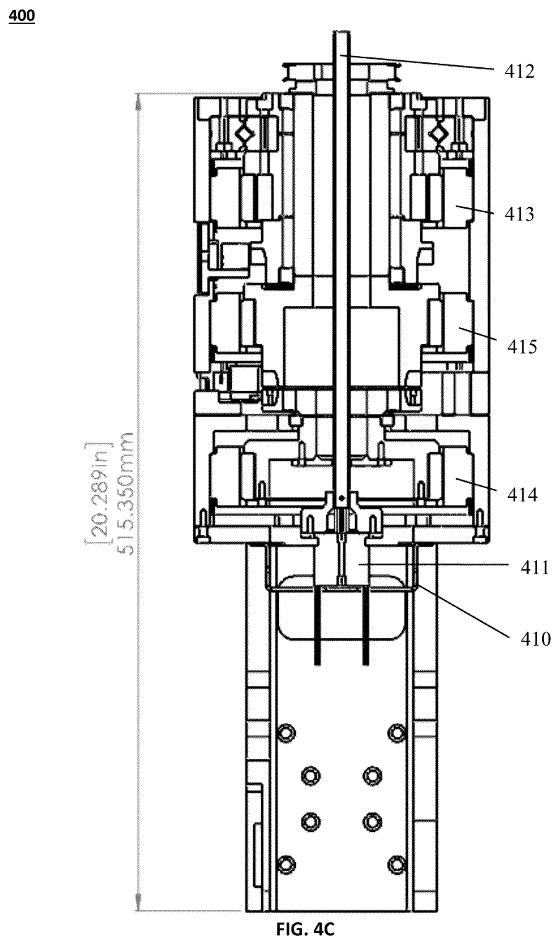

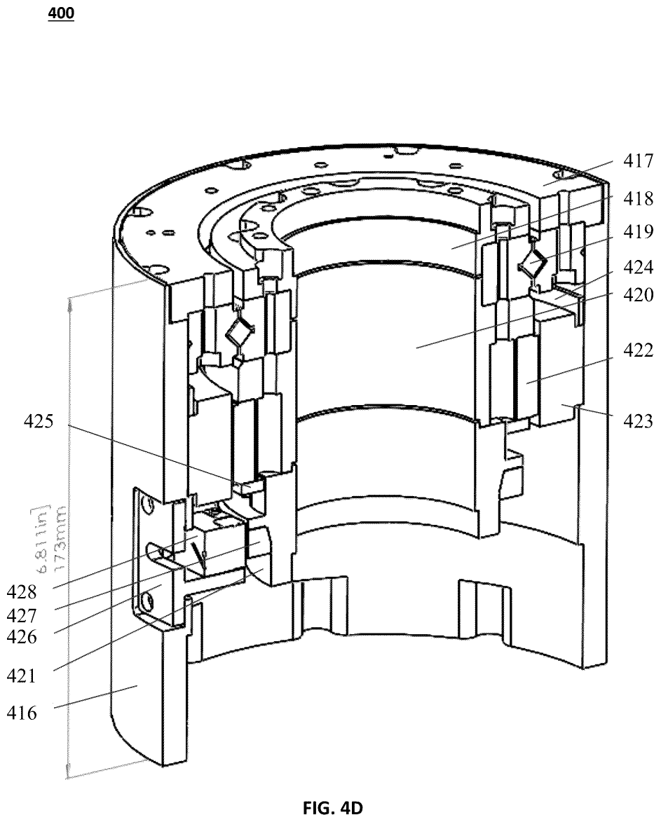

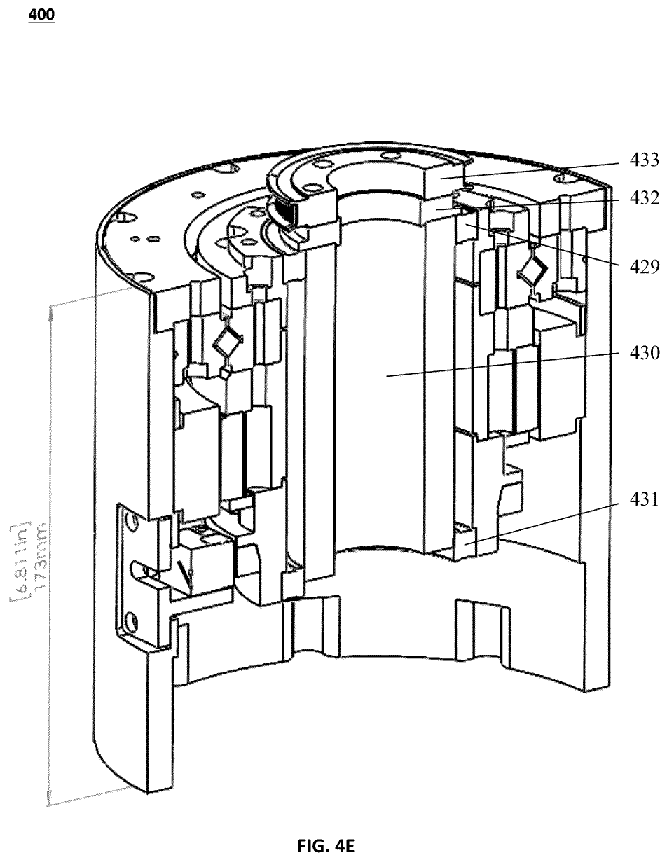

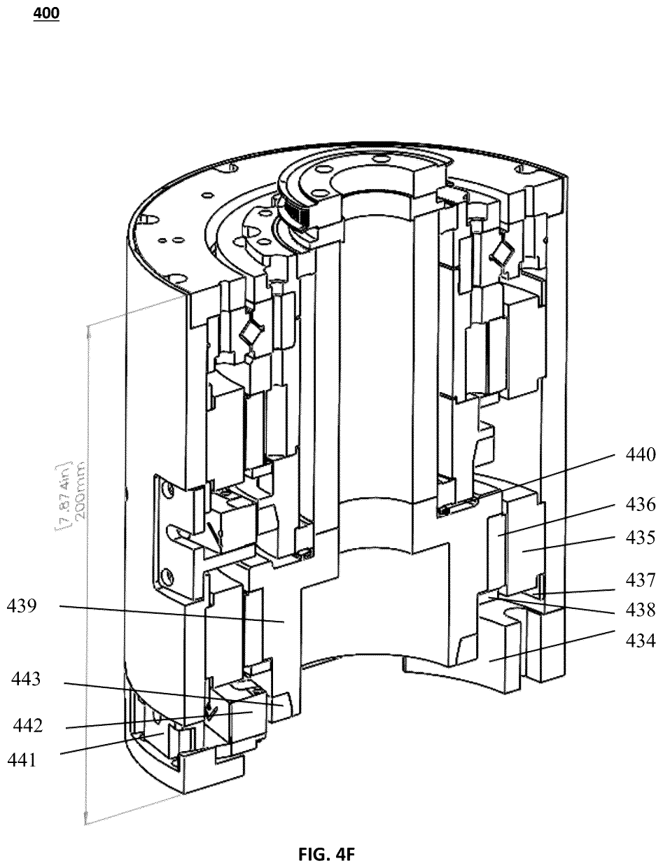

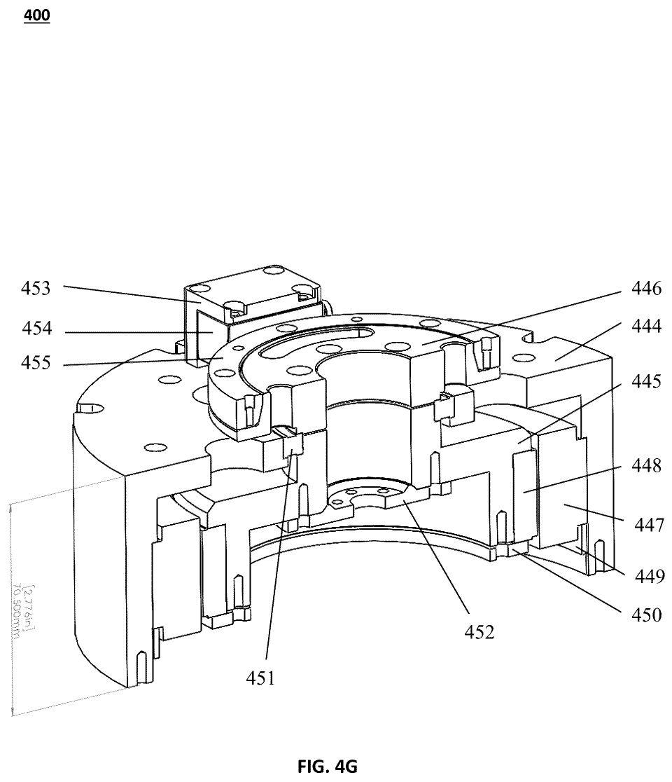

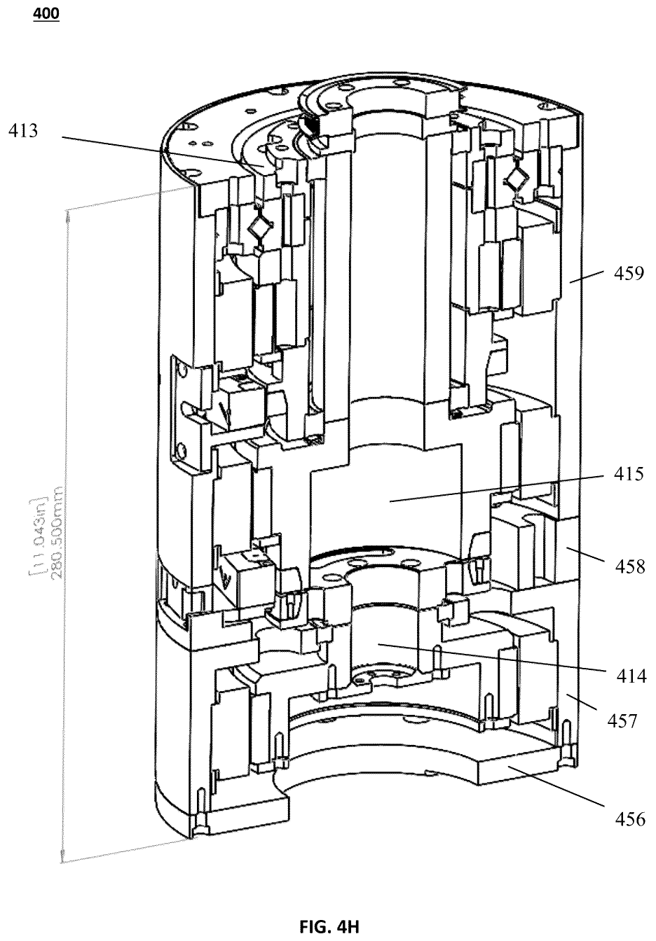

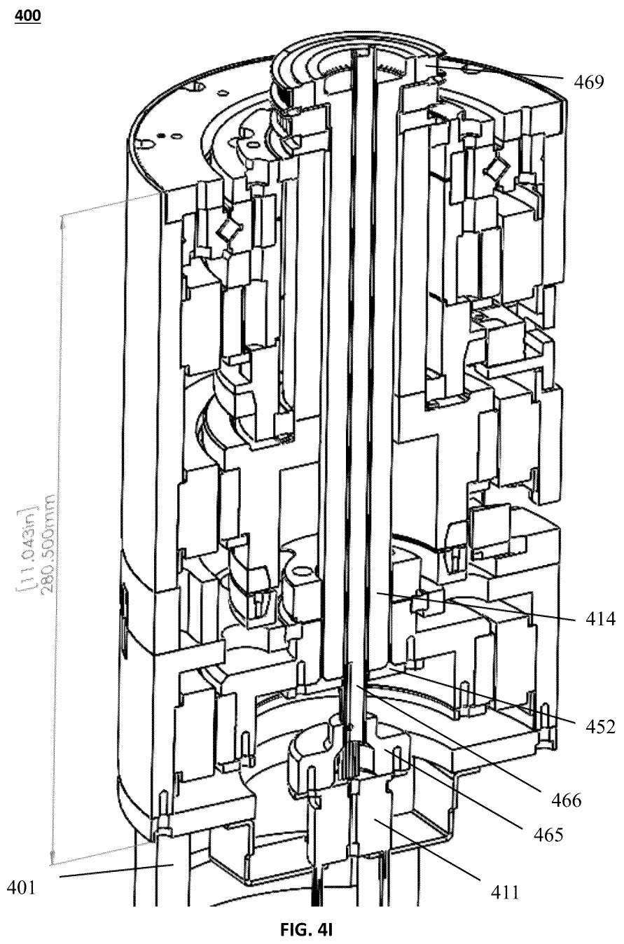

The robot apparatus 100 can be configured with a motor module 400. FIGS. 4A-4I illustrate the motor module 400 of the apparatus 100, which can be configured to control or affect operations during transferring of the sample. FIG. 4A illustrates a perspective view of the motor module 400, which can be configured to include: a Z pedestal 401; one or more energy chain mounting brackets 402; one or more limit switch flags 403; a right motor module cover 404; a left motor module cover 405; or a top motor module cover 406. FIG. 4B illustrates a perspective view of the motor module 400, which can be configured to include: a Z pedestal cover bracket 407; one or more encoder wiring channels 408; or one or more motor wiring channels 409. FIG. 4C illustrates a plan view (section view) of the motor module 400, which can be configured to include: one or more rotary union brackets 410; a rotary union 411; or one or more cable tubes 412. FIG. 4C further illustrates axis A 413, axis B 414, and axis C 415 of the apparatus 100. FIG. 4D illustrates a plan view (section view) of the motor module 400, which can be configured to include: an axis A housing 416; an axis A top plate 417; an axis A shaft crown 418; a cross roller bearing 419; an axis A shaft 420; an axis A shaft, bottom section 421; an axis A rotor 422; an axis A stator 423; one or more stator clamping rings 424; one or more rotor clamping rings 425; one or more encoder mounts 426; an encoder ring scale 427; or an absolute encoder 428. FIG. 4E illustrates a plan view (section view) of the motor module 400, which can be configured to include: an axis AC top bearing 429; an axis C shaft 430; an axis AC bottom bearing 431; an axis C shaft cap 432, or an axis C pulley #1 433. FIG. 4F illustrates a plan view (section view) of the motor module 400, which can be configured to include: one or more housing spacers 434; an axis C stator 435; an axis C rotor 436; one or more stator clamping rings 437; one or more rotor clamping rings 438; a shaft C, bottom section 439; one or more wave springs 440; one or more encoder mounts 426; an absolute encoder 428; or an encoder ring scale 427. FIG. 4G illustrates a plan view (section view) of the motor module 400, which can be configured to include: an axis B housing 444; an axis B shaft 445; an axis B shaft cap 446; an axis B stator 447; an axis B rotor 448; one or more stator clamping rings 449; one or more rotor clamping rings 450; one or more bearings 451; an axis B coupling plate 452; one or more encoder mounts 453; an absolute encoder 454; or an encoder ring scale 455. FIG. 4H illustrates a plan view (section view) of the motor module 400, which can be configured to include: a motor module base plate 456; an axis B housing 457; one or more housing spacers 458; or an axis A housing 459. FIG. 4H further illustrates axis A 413, axis B 414, and axis C 415 of the apparatus 100. FIG. 4I illustrates a plan view (section view) of the motor module 400, which can be configured to include: the Z pedestal 410; the rotary union 411; one or more rotary union clamps 465; one or more wiring tubes 466; or the axis B coupling plate 452; an axis B pulley #1 469. FIG. 4I further illustrates axis B 414 of the apparatus 100.

The motor module 400 can be configured with a predetermined size to accommodate the small footprint of the apparatus 100. In some cases, as illustrated in FIGS. 4A-4I, the motor module 400 can be sized with a diameter of about 190 millimeters (mm) and a height of about 515 mm. In some cases, the motor module 400 can be sized with a diameter of at least about 100-150 mm, 150 mm-200 mm, 200 mm-250 mm, 250 mm-300 mm, or greater. In some cases, the motor module 400 can be sized with a diameter of at most about 300-250 mm, 250 mm-200 mm, 200 mm-150, 150 mm-100 mm, or less. In some cases, the motor module 400 can be sized with a height of at least about 400 mm-450 mm, 450 mm-500 mm, 500 mm-550 mm, 550 mm-600 mm, or greater. In some cases, the motor module 400 can be sized with a height of at most about 600 mm-550 mm, 550 mm-400 mm, 400 mm-350 mm, 350 mm-300 mm, or less.

In some cases, the motor module 400 can be configured with direct drive motors (e.g., 3 identical direct drive motors along axis A 413, axis B 414, and axis C 415). In some cases, each direct drive motor can be configured to position one above the other within round housings or enclosures. In some embodiments, each of the first, the second, and the third direct drive motors is arranged concentrically with each of the other direct drive motors. In some cases, the direct drive motors can be coupled to a series of three concentric and hollow shafts. In some cases, for commutation and position tracking, the motor module 400 can be configured with an absolute encoder on each shaft. Various bearing arrangements can be used for mechanical functioning of the motor module 400. In some cases, within the centermost shaft of the motor module 400, a tube can be included for carrying signal wires and a vacuum tube from a rotary union mounted on the lowest part of the motor module 400. In some cases, the tube may terminate within the arm module 500, which can be mounted directly onto the outermost shaft of the motor module 400. In some cases, one or more panels or covers (e.g., 2 panels or covers) can enclose or house the motor module 400.

In some embodiments, the motor module 400 further comprises a first direct drive motor, along axis A 413, configured to operate the one or more arms. In some embodiments, the motor module 400 further comprises a second direct drive motor, along axis C 415, configured to operate the one or more arms. In some embodiments, the motor module 400 further comprises a third direct drive motor, along axis B 414, configured to operate the one or more arms. In some embodiments, collective operation of the first, the second, and the third direct drive motors is configured to transfer the sample along any axis of the one or more horizontal axes. In some embodiments, each of the first, the second, and the third direct drive motors is arranged above or below each of the other direct drive motors

In some embodiments, the motor module 400 further comprises a first shaft operatively coupled to and concentrically aligned inside the first direct drive motor (along axis A 413) and configured to transmit a mechanical force to the one or more arms via one or more cross roller bearings. In some embodiments, the motor module 400 further comprises a second shaft operatively coupled to and concentrically aligned inside of the second direct drive motor (along axis C 415) and configured to transmit a mechanical force to the one or more arms arm via one or more pulleys and one or more timing belts. In some embodiments, the motor module 400 further comprises a third shaft operatively coupled to and concentrically aligned inside of the third direct drive motor (along axis B 414) and configured to transmit a mechanical force to the one or more arms arm via one or more pulleys and one or more timing belts. In some embodiments, collective operation of the first, the second, and the third shafts by the motor module 400 is configured to transfer the sample along any axis of the one or more horizontal axes. In some embodiments, the second shaft is concentrically aligned inside the first shaft and wherein the third shaft is concentrically aligned inside the second shaft.

In some embodiments, the motor module 400 further comprises a conduit configured to carry one or more control signal wires from the controller module 200 to the arm module 500 or the motor module 400. In some embodiments, the motor module 400 further comprises a conduit configured to carry a vacuum line from a vacuum source to the one or more interchangeable end effectors 700 or 800 via the arm module 500. In some embodiments, the conduit is concentrically aligned inside of the third shaft and is attached to a first arm of the one or more arms.

### Arm Module

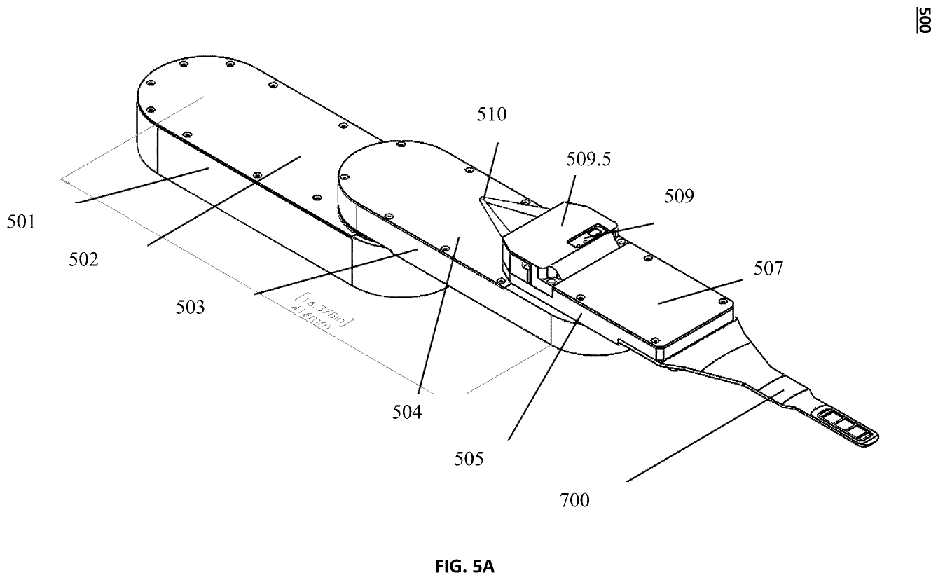

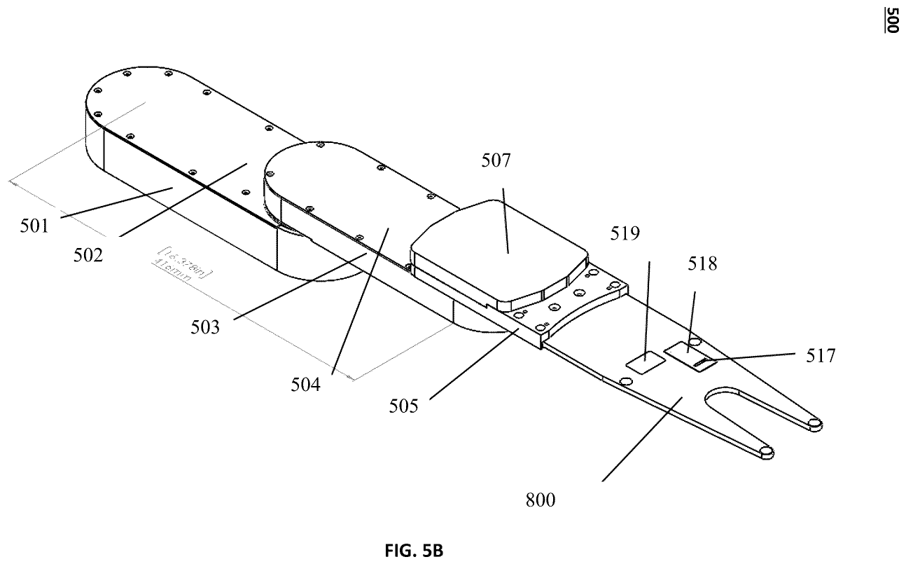

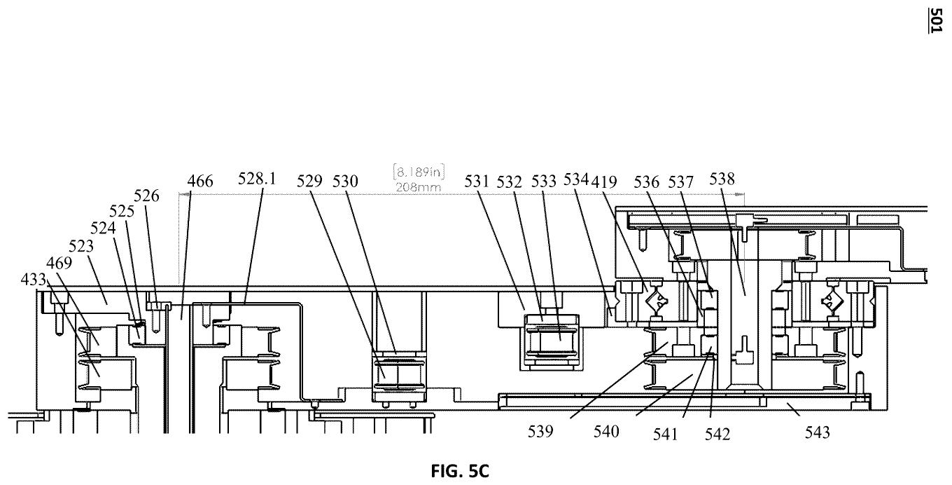

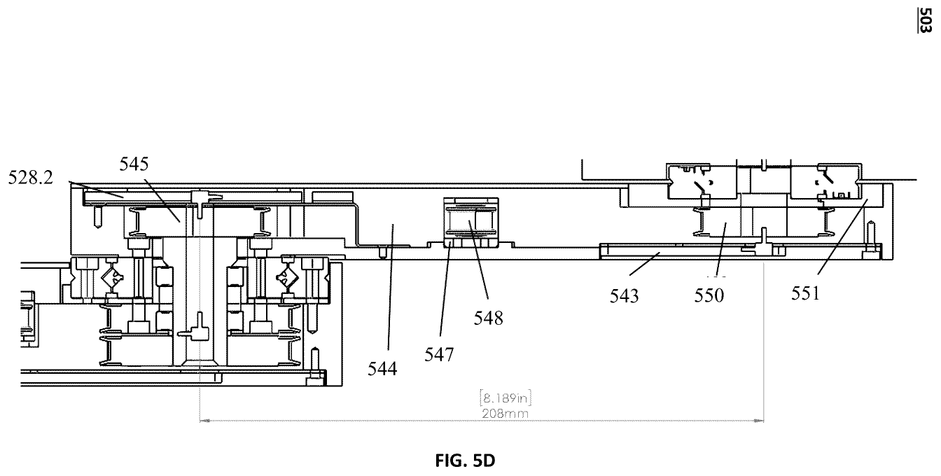

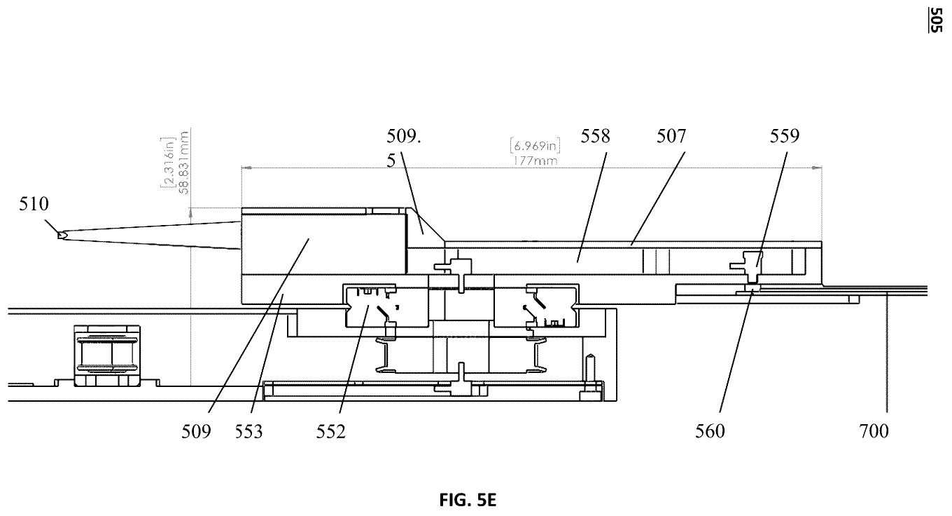

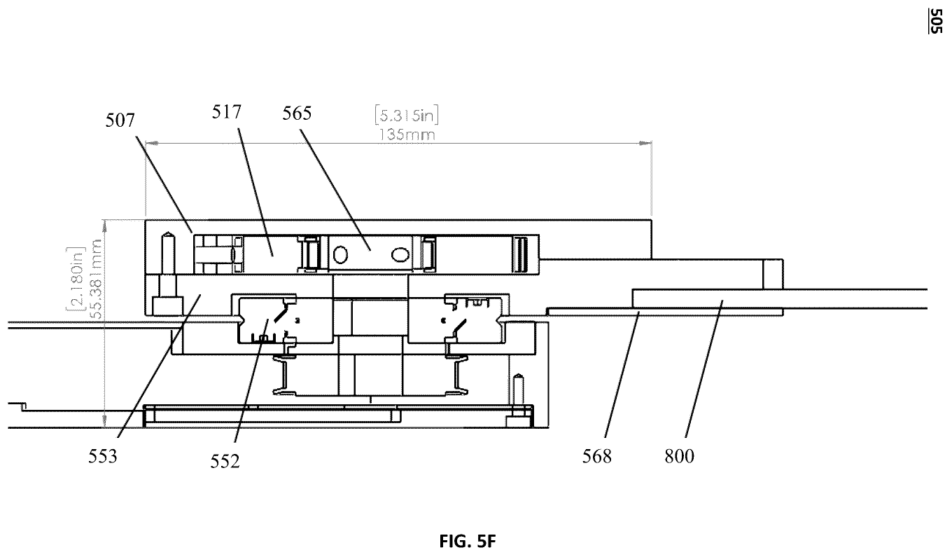

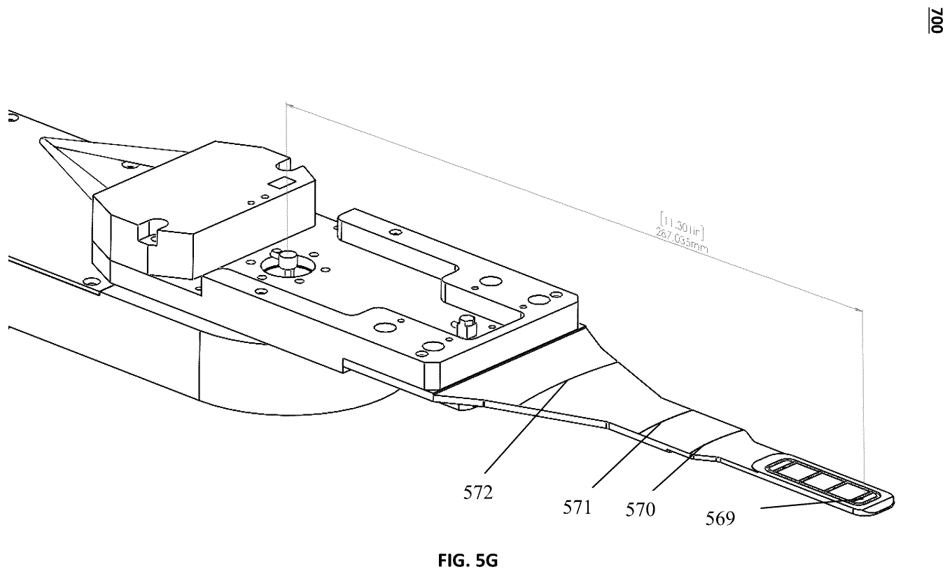

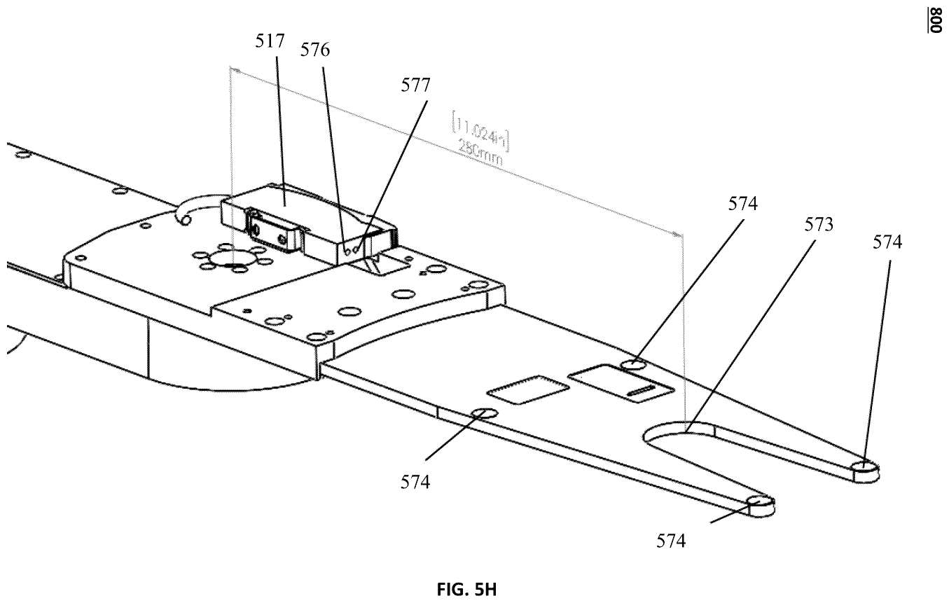

The robot apparatus 100 can be configured with an arm module 500. FIGS. 5A-5H illustrate the arm module 500 of the apparatus 100, which can be configured to control or affect operations during transferring of the sample. FIG. 5A illustrates a perspective view of the arm module 500 configured for transferring a sample, e.g., a wafer, which can be configured to include: an arm A 501; one or more arm A covers 502; an arm B 503; one or more arm B covers 504; an arm C 505; an end effector for wafers 700; one or more arm C covers 507; one or more wafer presence scanner covers 509.5; a wafer presence scanner 509; or a wafer presence scanner measurement location 510. FIG. 5B illustrates a perspective view of the arm module 500 configured for transferring a sample, e.g., a photomask, which can be configured to include: the arm A 501; the arm A cover 502; the arm B 503; the arm B cover 504; the arm C 505; a photomask end effector 800; a photomask presence sensor 517; a photomask presence sensor cover 518; a photomask alignment cutout 519; or the arm C cover 507. FIG. 5C illustrates a plan view (section view) of the arm module 500, e.g., the arm A 501, which can be configured to include: the axis C pulley #1 433; the axis B pulley #1 469; an arm A cap 523; one or more bearings 524; one or more wave springs 525; a wiring tube key 526; the wiring tube 466; a wiring bridge 528.1; a tensioner pulley 529; a tensioner mount 530; a structural bridge 531 for tensioner mount 530; a tensioner mount 532; a tensioner pulley 533; one or more stainless steel bearing mounts 534; the cross roller bearing 419; a concentricity sleeve 536; one or more bearings 537; a joint A-B shaft 538; an axis B pulley #2 539; an axis C pulley #2 540; one or more bearings 541; or one or more spacers 542; or an arm B bottom cover 543. FIG. 5D illustrates a plan view (section view) of the arm module 500, e.g., the arm B 503, which can be configured to include: an arm B main body 544; an axis C pulley #3 545; the wiring bridge 528.2; a tensioner mount 547; a tensioner pulley 548; the arm B bottom cover 543, an axis C pulley #4 550; or a stainless steel bearing mount 551. FIG. 5E illustrates a plan view (section view) of the arm module 500, e.g., the arm C 505, for transferring a sample, e.g., a wafer, which can be configured to include: a cross roller bearing 552; an arm C main body 553; the wafer presence scanner 509; the wafer presence scanner measurement location 510; the wafer presence scanner cover 509.5; the arm C cover 507; one or more hollow areas for wiring 558; one or more vacuum connectors 559; one or more vacuum channels 560; or the wafer end effector 700. FIG. 5F illustrates a plan view (section view) of the arm module 500, e.g., the arm C 505, for transferring a sample, e.g., a photomask, which can be configured to include: the cross roller bearing 552; the arm C main body 553; the arm C top cover 507; one or more brackets 565; the photomask presence sensor 517 (e.g., laser source/detector); the photomask end effector 800; or an arm C bottom cover 568.

The arm module 500 can be configured with a predetermined size to accommodate the small footprint of the apparatus 100. In some cases, as illustrated in FIGS. 5A-5H, the arm module 500 can be sized with a width of about 50 millimeters (mm), a length of about 400 mm, and a depth of about 50 mm. In some cases, the arm module 500 can be sized with a width of at least about 20 mm-30 mm, 30 mm-40 mm, 40 mm-50 mm, 50 mm-60 mm, 60 mm-70 mm, 70 mm-80 mm, or greater. In some cases, the arm module 500 can be sized with a width of at most about 80 mm-70 mm, 70 mm-60 mm, 60 mm-50 mm, 50 mm-40 mm, 40 mm-30 mm, 30 mm-20 mm, or less. In some cases, the arm module 500 can be sized with a length of at least about 300 mm-350 mm, 350 mm-400 mm, 400 mm-450 mm, 450 mm-500 mm, 500 mm-550 mm, 550 mm-600 mm, or greater. In some cases, the arm module 500 can be sized with a length of at most about 600 mm-550 mm, 550 mm-500 mm, 500 mm-450 mm, 450 mm-400 mm, 400 mm-350 mm, 350 mm-300 mm, or less. In some cases, the arm module 500 can be sized with a depth of at least about 20 mm-30 mm, 30 mm-40 mm, 40 mm-50 mm, 50 mm-60 mm, 60 mm-70 mm, 70 mm-80 mm, or greater. In some cases, the arm module 500 can be sized with a depth of at most about 80 mm-70 mm, 70 mm-60 mm, 60 mm-50 mm, 50 mm-40 mm, 40 mm-30 mm, 30 mm-20 mm, or less

As described herein, the arm module 500 can be configured with one or more arms (e.g., 3 arms). In some cases, one or more interchangeable end effectors 700 or 800 can be mounted or attached to a final arm (e.g., a third arm) of the one or more arms. In some cases, each arm can be configured to (i) support the subsequent arm and (ii) transfer motor power mechanically from the motor module 400 to any subsequent arm. In some cases, one or more signal wires or a vacuum tube can be routed through the arm module 500 starting from a previous termination point above the motor module 400 and ending in the final arm (e.g., the third arm). In some cases, the one or more signal wires can connect to one or more sensors or to the one or more interchangeable end effectors 700 or 800.

In some cases, the first arm of the one or more arms of the arm module 500 can be configured to directly mount to the motor module 400. In some cases, the first arm can be configured with unrestricted rotation (e.g., 360 degrees of rotation). In some cases, the first arm can be configured with a cross roller bearing positioned at the end of the first arm for mounting of the second arm. In some cases, the cross roller bearing can be configured with one or more concentric thin steel plates (e.g., 2 plates) with one or more nubs for limiting rotation of the second arm. In some cases, the rotation of the second arm can be limited to at least about 180°-225°, 225°-270°, 270°-315°, or 315°-350°. In some cases, a pulley can be configured to mount to the bottom of the cross roller bearing and linked via a timing belt to another pulley mounted on the centermost shaft within the motor module 400. In some cases, inside a central opening of the cross roller bearing, can be included a set of ball bearings securing a hollow shaft. In some cases, the hollow shaft can be configured to operatively couple to a pulley which in turn can be linked via a timing belt to a pulley on the centermost shaft in the motor module 400. In some cases, the first arm can be configured with one or more pulley tensioners and a wire routing system.

The first arm can be configured with a predetermined size to accommodate the small footprint of the apparatus 100. In some cases, the first arm can be sized with a length of about 210 millimeters (mm, measured joint to joint), a width of about 105 mm, and a thickness of about 45 mm. In some cases, the first arm can be sized with a length of at least about 100 mm-150 mm, 150 mm-200 mm, 200 mm-250 mm, or greater. In some cases, the first arm can be sized with a length of at most about 250 mm-200 mm, 200 mm-150 mm, 150 mm-100 mm, or less. In some cases, the first arm can be sized with a width of at least about 50 mm-75 mm, 75 mm-100 mm, 100 mm-125 mm, 125 mm-150 mm, or greater. In some cases, the first arm can be sized with a width of at most about 150 mm-125 mm, 125 mm-100 mm, 100 mm-75 mm, 75 mm-50 mm, or less. In some cases, the first arm can be sized with a thickness of at least about 25 mm-30 mm, 30 mm-35 mm, 35 mm-40 mm, 40 mm-45 mm, 45 mm-50 mm, 50 mm-55 mm, 55 mm-60 mm, 60 mm-65 mm, or greater. In some cases, the first arm can be sized with a thickness of at most about 65 mm-60 mm, 60 mm-55 mm, 55 mm-50 mm, 50 mm-45 mm, 45 mm-40 mm, 40 mm-35 mm, 35 mm-30 mm, 30 mm-25 mm, or less.

In some cases, the second arm of the one or more arms of the arm module 500 can be configured to directly mount to the cross roller bearing positioned at the end of the first arm. In some cases, another cross roller bearing can be positioned at the end of the second arm for mounting the third arm. In some cases, the cross roller bearing can be configured with one or more concentric thin steel plates (e.g., 2 plates) with one or more nubs for limiting rotation of the third arm. In some cases, the rotation of the third arm can be limited to at least about 180°-225°, 225°-270°, 270°-315°, or 315°-350°. In some cases, a pulley can be configured to mount to the bottom of the cross roller bearing and linked via a timing belt to another pulley mounted to the small shaft from the previous arm. In some cases, the pulley can be configured to link to the centermost shaft of the motor module 400. In some cases, the second arm can be configured with pulley tensioners and a wire routing system.

The second arm can be configured with a predetermined size to accommodate the small footprint of the apparatus 100. In some cases, the second arm can be sized with a length of about 210 millimeters (mm, measured joint to joint), a width of about 95 mm, and a thickness of about 25 mm. In some cases, the second arm can be sized with a length of at least about 100 mm-150 mm, 150 mm-200 mm, 200 mm-250 mm, or greater. In some cases, the second arm can be sized with a length of at most about 250 mm-200 mm, 200 mm-150 mm, 150 mm-100 mm, or less. In some cases, the second arm can be sized with a width of at least about 50 mm-75 mm, 75 mm - 100 mm, 100 mm-125 mm, 125 mm-150 mm, or greater. In some cases, the second arm can be sized with a width of at most about 150 mm-125 mm, 125 mm-100 mm, 100 mm-75 mm, 75 mm-50 mm, or less. In some cases, the second arm can be sized with a thickness of at least about 25 mm-30 mm, 30 mm-35 mm, 35 mm-40 mm, 40 mm-45 mm, 45 mm-50 mm, 50mm-55 mm, 55 mm-60 mm, 60 mm-65 mm, or greater. In some cases, the second arm can be sized with a thickness of at most about 65 mm-60 mm, 60 mm-55 mm, 55 mm-50 mm, 50 mm-45 mm, 45 mm-40 mm, 40 mm-35 mm, 35 mm-30 mm, 30 mm-25 mm, or less.

In some cases, the third arm of the one or more arms of the arm module 500 can be configured to directly mount to the cross roller bearing positioned at the end second arm. In some cases, the one or more interchangeable end effectors 700 or 800 can mount to or be positioned at the end of the third arm. The third arm can be configured with a predetermined size to accommodate the type of end effector 700 or 800 and the small footprint of the apparatus 100. In some cases, the third arm can be sized with a length of about 210 millimeters (mm, measured joint to joint). In some cases, the third arm can be sized with a length of at least about 100 mm-150 mm, 150 mm-200 mm, 200 mm-250 mm, or greater. In some cases, the third arm can be sized with a length of at most about 250 mm-200 mm, 200 mm-150 mm, 150 mm-100 mm, or less. In some cases, the third arm can be sized with a width of at least about 50 mm-75 mm, 75 mm-100 mm, 100 mm-125 mm, 125 mm-150 mm, or greater. In some cases, the third arm can be sized with a width of at most about 150 mm-125 mm, 125 mm-100 mm, 100 mm-75 mm, 75 mm-50 mm, or less. In some cases, the third arm can be sized with a thickness of at least about 25 mm-30 mm, 30 mm-35 mm, 35 mm-40 mm, 40 mm-45 mm, 45 mm-50 mm, 50 mm-55 mm, 55 mm-60 mm, 60 mm-65 mm, or greater. In some cases, the third arm can be sized with a thickness of at most about 65 mm-60 mm, 60 mm-55 mm, 55 mm-50 mm, 50 mm-45 mm, 45 mm-40 mm, 40 mm-35 mm, 35 mm-30 mm, 30 mm-25 mm, or less.

In some embodiments, the arm module 500 further comprises a first arm of the one or more arms operatively coupled to a first cross roller bearing of the motor module 400 and configured with a second cross roller bearing associated with a first set of one or more shafts, one or more pulleys, one or more timing belts, one or more concentric steel plates, or one or more stops. In some embodiments, the arm module 500 further comprises a second arm of the one or more arms operatively coupled to the second cross roller bearing of the first arm and configured with a third cross roller bearing associated with a second set of one or more shafts, one or more pulleys, one or more timing belts, one or more concentric steel plates, or one or more stops. In some embodiments, the arm module 500 further comprises a third arm of the one or more arms operatively coupled to the third cross roller bearing of the second arm, wherein the third arm is configured to releasably hold the one or more interchangeable end effectors 700 or 800. In some embodiments, collective operation of the first, the second, and the third arms by the arm module 500 is configured to transfer the sample along any axis of the one or more horizontal axes. In some embodiments, each of the one or more arms of the arm module 500 comprises a three-joint arm module. In some embodiments, each of the one or more arms of the arm module 500 do not comprise an integrated motor. In some embodiments, the apparatus 100 is configured to maintain a fixed orientation of the sample relative to the apparatus 100 during transferring of the sample or during a stationary position of the sample to avoid one or more collisions of the sample

### Interchangeable end Effectors

The robot apparatus 100 can be configured with one or more interchangeable end effectors 700 or 800 (or “end effectors”) for transferring different samples. Interchangeable end effectors 700 or 800 can provide for easier configuration changes between wafer handling and photomask handling.

### End Effectors for Wafers

The robot apparatus 100 can be configured with an end effector 700 for transferring wafers of different sizes and types. FIG. 5G illustrates a perspective view of the arm module 500, e.g., the arm C 505, for transferring a sample, e.g., a wafer, by the end effector 700, which can be configured to include: a central location for releasably holding a wafer 569; a wafer edge location for a 150 millimeter wafer 570; a wafer edge location for a 200 millimeter wafer 571; or a wafer edge location for a 300 millimeter wafer 572. In some cases, a vacuum pressure is configured to be applied in or near the central location 569 for releasably holding a wafer.

The end effector 700 can be configured with a predetermined size to accommodate the small footprint of the apparatus 100. In some cases, as illustrated in FIG. 5G, the end effector 700 can be sized with a length of about 280 millimeters (mm). In some cases, the end effector 700 can be sized with a length of at least about 200 mm-250 mm, 250 mm-300 mm, 300 mm-350 mm, or greater. In some cases, the end effector 700 can be sized with a length of at most about 350 mm-300 mm, 300 mm-250 mm, 250 mm-200 mm, or less.

In some cases, the end effector 700 for wafer handling can be configured with a wafer presence scanner 509. In some cases, the wafer presence scanner 509 can be configured to use a vacuum strength and gauge to determine a presence of the wafer. In some cases, the wafer presence scanner 509 can be configured to use a physical switch or an optical sensor to determine a presence of a the wafer. In some cases, the wafer presence scanner 509 can be mounted to the third arm using one or more taps (e.g., taps on the back half). In some cases, the wafer presence scanner 509 can be configured with one or more wires running through the arm module 500. In some cases, the third arm (e.g., on the front half of the arm) can be configured with one or more screw holes for mounting of the end effector 700 to the third arm. In some cases, a smaller tap can be configured to open into the vacuum channel of the end effector 700 for termination of the vacuum tube that runs through the arms of the arm module 500. In some cases, the end effector 700 for wafer handling can include one or more mounting points for panels or covers.

In some cases, the end effector 700 for wafer handling can include a thinner end effector than the end effector 800 for photomask handling. In some cases, the end effector 700 for wafer handling can include a vacuum configured to releasably hold the sample, e.g., a wafer. In some cases, the end effector 700 for wafer handling can be fabricated from stainless steel and PEEK. In some cases, the end effector 700 for wafer handling can be configured with a thickness at the tip of at least about 1 mm-2 millimeters (mm), 2 mm-3 mm, 3 mm-4 mm, 4 mm-5 mm, or greater. In some cases, the end effector 700 for wafer handling can be configured with a thickness at the tip of at most about 5 mm-4 mm, 4 mm-3 mm, 3 mm-2 mm, 2 mm-1 mm, or less. In some cases, the thickness can be sized to allow for ample space when transferring wafers from a cassette.

In some cases, the vacuum strength for wafer handling can be at least about 0-10 kilopascal (kPa), 10 kPa-50 kPa, 50 kPa-100 kPa, or greater. In some cases, the vacuum strength for wafer handling can be at most about 100 kPa-50 kPa, 50 kPa-10 kPa, or 10 kPa-0 kPa. In some cases, the vacuum strength for wafer handling can be determined based on sample presence and supplied vacuum pressure. In some cases, the vacuum strength can be determined or measured (e.g., vacuum gauge) within the robot apparatus 100 at all times (e.g., real time) to function as a wafer presence scanner 509. In some cases, a solenoid internal to the robot apparatus 100 can trigger the vacuum on, off, or at intermediate pressures.

In some cases, the robot apparatus 100 can be configured with 4-axis control to pick or place externally stored wafers. In some cases, the robot apparatus 100 can be configured with 3-axis control to transfer wafers. The 4-axis control can reduce or eliminate the risk of, e.g., colliding the wafer with the wafer's cassette. In some cases, the 4-axis control can transfer the wafer along one or more straight lines or linear paths. In some cases, the one or more straight lines or linear paths may not be radially aligned with a center of the robot apparatus 100. In some cases, after the one or more a straight lines or linear paths, the robot apparatus 100 can use a homing sequence configured to (i) transfer the wafer to the center of the robot apparatus 100 and (ii) begin performing a next set of transfer operations or sequences. In some cases, after the one or more a straight lines or linear paths, the robot apparatus 100 can use a homing sequence configured to (i) transfer the wafer to a predetermined distance from the center of the robot apparatus 100 such that the end effector 700 is radially aligned with the robot apparatus 100 and (ii) begin performing a next set of transfer operations or sequences. In some cases, the predetermined distance can be selected by the user. In some cases, the predetermined distance can be determined by the robot apparatus 100. In some cases, in order to maximize throughput, the 4-axis control can also rotate the wafer as needed to bring the arms of the arm module 500 into a convenient orientation for subsequent transfer operations or sequences. The small footprint of the arms of the arm module 500 can also allow close placement of different peripherals to the robot apparatus 100 for wafer handling, e.g., alignment stations or permanent storage location stations.

In some embodiments, the one or more interchangeable end effectors comprises a first end effector 700 configured to releasably hold a wafer. In some embodiments, the first end effector 700 is further configured to operatively couple to a vacuum for releasably holding the wafer. In some embodiments, the first end effector 700 is further configured to operatively couple to a sensor for determining a presence of the wafer, wherein the sensor comprises a vacuum sensor. In some embodiments, the apparatus 100 is configured to rotate the sample relative to the apparatus 100 during transferring of the sample or during a stationary position of the sample.

### End Effectors for Photomasks

The robot apparatus 100 can be configured with an end effector 800 for transferring photomasks of different sizes and types. FIG. 5H illustrates a perspective view of the arm module 500, e.g., the arm C 505, for transferring a sample, e.g., a photomask, by the end effector 800, which can be configured to include: a central location for releasably holding a photomask 537; one or more Peek edge contact pads 574; the photomask presence sensor 517 (e.g., a laser source/detector); one or more fiber ports for detection 576 with sensor 517; or one or more fiber ports for emission 577 with sensor 517.

The end effector 800 can be configured with a predetermined size to accommodate the small footprint of the apparatus 100. In some cases, as illustrated in FIG. 5H, the end effector 800 can be sized with a length of about 280 millimeters (mm). In some cases, the end effector 800 can be sized with a length of at least about 200 mm-250 mm, 250 mm-300 mm, 300 mm-350 mm, or greater. In some cases, the end effector 800 can be sized with a length of at most about 350 mm -300 mm, 300 mm-250 mm, 250 mm-200 mm, or less.

In some cases, the end effector 800 for photomask handling can be configured with one or more taps on its back half for mounting of the laser amplifier unit of the photomask presence sensor 517. In some cases, the amplifier can be connected to the limited reflectance unit within the photomask end effector 800 over a pair of fiber optic strands. In some cases, the amplifier can be connected to the wires running through the arm module 500. In some case, on the front half of the third arm, can be included one or more screw holes for mounting of the end effector 800. In some cases, the end effector 800 for wafer handling can include one or more mounting points for panels or covers.

In some cases, the robot apparatus 100 can be configured with 3-axis control to transfer photomasks. In some cases, the robot apparatus 100 can be configured with 4-axis control to transfer photomasks. In some cases, the end effector 800 for photomask handling can include a thicker end effector than the end effector 700 for wafer handling, which can prevent bending under load of the heavier photomask. In some cases, the end effector 800 for photomask handling can be fabricated from stainless steel. In some cases, the end effector 800 for photomask handling can be configured with a thickness of at least about 1 mm-2 millimeters (mm), 2 mm-3 mm, 3 mm-4mm, 4 mm-5 mm, or greater. In some cases, the end effector 800 for photomask handling can be configured with a thickness of at most about 5 mm-4 mm, 4 mm-3 mm, 3 mm-2 mm, 2 mm-1 mm, or less. In some cases, the thickness can be sized to allow for ample space when transferring the photomask between stations. In some cases, the end effector 800 for photomask handling can include one or more pads (e.g. 4 PEEK pads) configured to achieve an edge-only contact as a precaution against possible contamination or damage to the photomask during transfer between stations, e.g., from a photomask cassette to a station.

In some cases, the end effector 800 for photomask handling can be configured with a photomask presence sensor 517. In some cases, the sensor can be an optical sensor configured with a limited reflected fiber unit integrated within the end effector 800. The optical sensor can be configured with a one or more emitting sources (e.g., 1 source), one or more emission detectors (e.g., 1 detector), and one or more sensor heads (e.g., 1 sensor head). In some cases, the source, detector, and head can be connected by one or more fiber optic cables (e.g., 2 fiber optic cables). In some cases, the emitting source can emit a 625 nanometer (nm) light. The light can be directed to the sensor through a first fiber optic cable. The light can exit the sensor head at an angle and, if a photomask is present within the working distance (e.g., about 0 mm-15 mm), the light can be reflected into a receiving hole on the sensor head. Then, the light can be guided into the emission detector and digitized. In some cases, the optical sensor can be configured with a high sensitivity allowing for limited reflectance. In some cases, the sensitivity can allow for a reflectivity of at least 1%-2%, 2%-3%, 3%-4%, 4%-5%, 5%-6%, 6%-7%, 7%-8%, or greater. In some cases, the sensitivity can allow for a reflectivity of at most 8%-7%, 7%-6%, 6%-5%, 5%-4%, 4%-3%, 3%-2%, 2%-1%, or less.

In some cases, the 4-axis control can be used to pick or place photomasks without risk of collision by transferring or moving the photomask along one or more straight lines or linear paths. In some cases, the one or more straight lines or linear paths may not be radially aligned with a center of the robot apparatus 100. In some cases, after the one or more a straight lines or linear paths, the robot apparatus 100 can use a homing sequence configured to (i) transfer the photomask to the center of the robot apparatus 100 and (ii) begin performing a next set of transfer operations or sequences. In some cases, after the one or more a straight lines or linear paths, the robot apparatus 100 can use a homing sequence configured to (i) transfer the photomask to a predetermined distance from the center of the robot apparatus 100 such that the end effector 800 is radially aligned with the robot apparatus 100 and (ii) begin performing a next set of transfer operations or sequences. In some cases, the predetermined distance can be selected by the user. In some cases, the predetermined distance can be determined by the robot apparatus 100. In some cases, photomasks can be rectangular so a rotation of the photomask can pose a collision risk depending on the geometry of the storage device, e.g., a photomask cassette. In some cases, the 4-axis control can maintain an orientation of the photomask during the one or more straight lines or linear paths.

In some cases, each end effector 700 or 800 and the last arm segment (e.g., arm C 505) can be interchanged to switch between one end effector and the other. In some cases, each end effector 700 or 800 can be interchanged to switch between one end effector and the other.

In some embodiments, the one or more interchangeable end effectors comprises a second end effector 800 configured to releasably hold a photomask. In some embodiments, the second end effector 800 is further configured to operatively use one or more pads for contacting the photomask along one or more edges of the photomask. In some embodiments, the second end effector 800 is further configured to and operatively couple to a sensor for determining a presence of the photomask, wherein the sensor comprises a limited reflected fiber unit.

### Controller Module

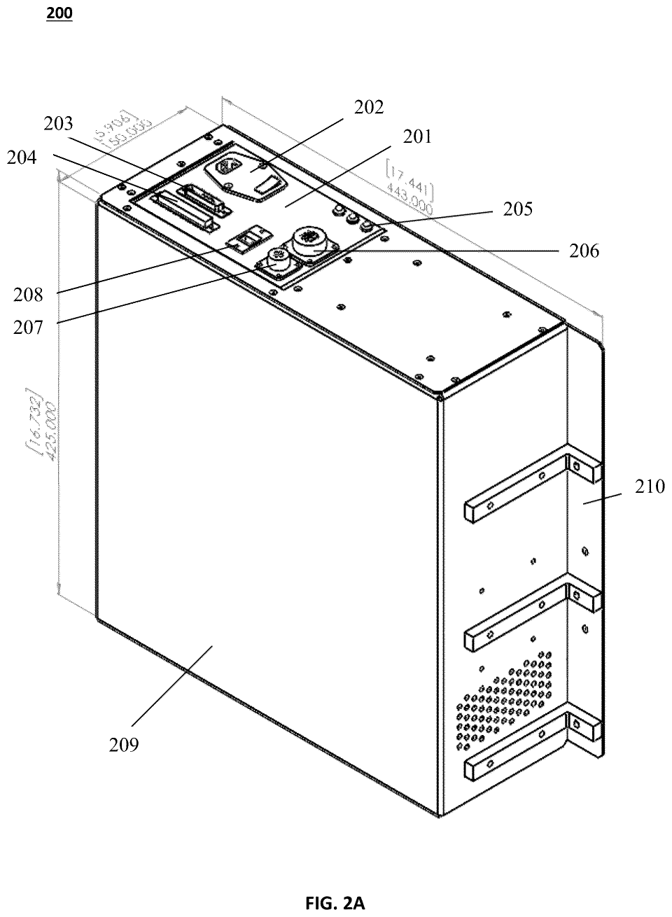

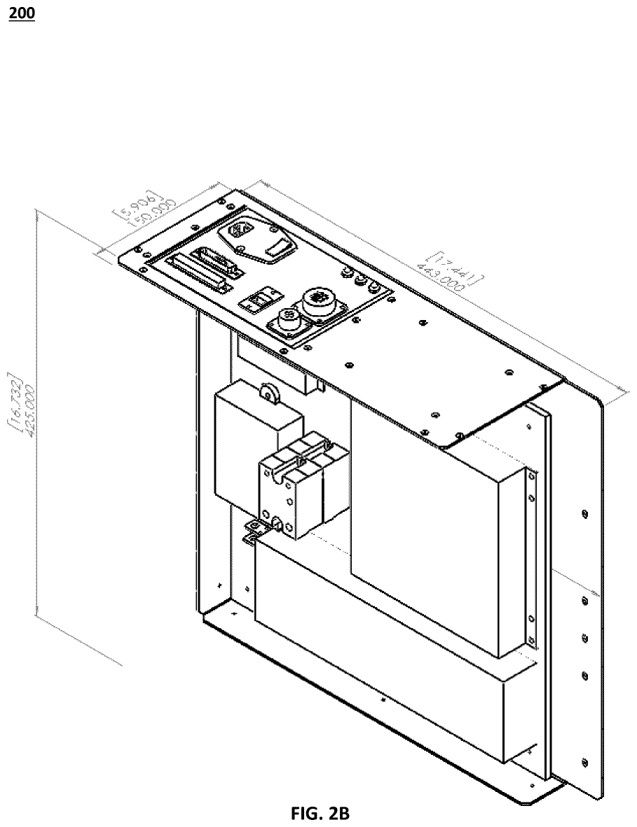

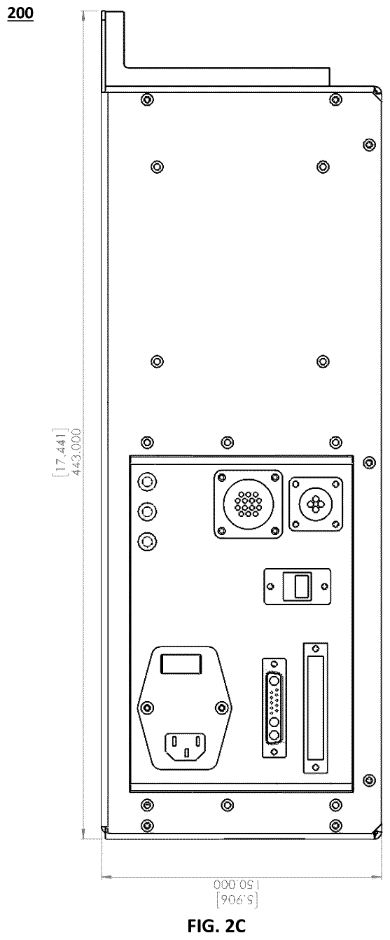

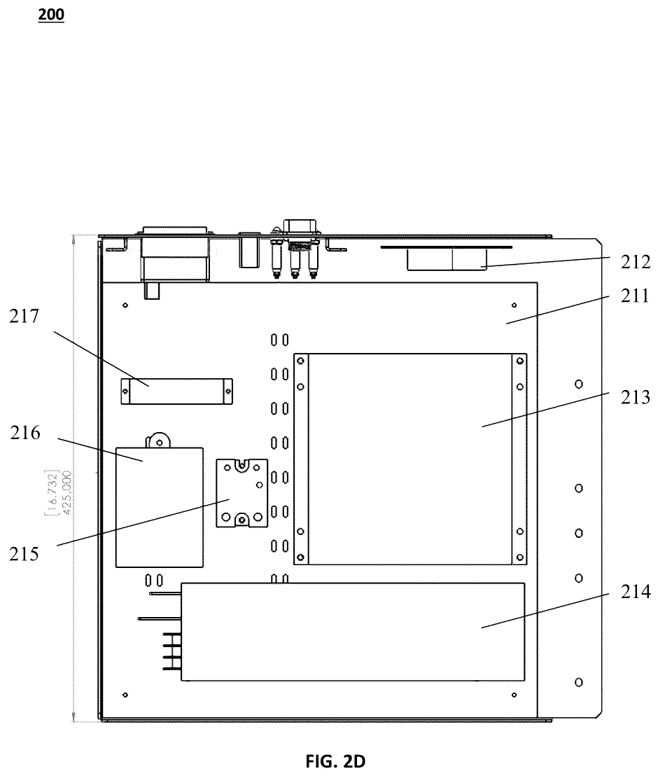

The robot apparatus 100 can be configured with a controller module 200 for handling all electrical and processing requirements of the robot apparatus 100. FIGS. 2A-2D illustrate the controller module 200 of the apparatus 100, which can be configured to control or affect operations during transferring of the sample. FIG. 2A illustrates that the controller module 200 can be configured to include: one or more controller module electronics panels 201; one or more power inlets 202 (e.g., configured to receive 90-265 volts alternating current (VAC), e.g., 115 VAC at 15 amps (A), 230 VAC at 8.5 A, or any suitable combination of voltage and current); one or more encoder cable connectors 203, one or more peripheral cable connectors 204; one or more status light emitting diodes (LEDs) 205; one or more motor power connectors 206; one or more emergency off (EMO) inlets 207 (e.g., configured to receive 24 volts direct current (VDC)); one or more communications ports 208 (e.g., ethernet ports); one or more controller module covers or panels 209 (e.g., a front cover); or one or more controller module mounting surfaces 210. FIG. 2B illustrates a perspective view of the controller module 200 without panels or covers. FIG. 2C illustrates a plan view (top view) of the controller module 200 without panels or covers.

FIG. 2D illustrates a plan view (front view) of the controller module 200 without panels or covers. FIG. 2D further illustrates that the controller module 200 can be configured to include: one or more isolation surfaces 211; one or more motor inductance boards 212; one or more motor controller units 213; one or more enclosed switching power supplies 214 (e.g., AC/DC); one or more brake and vacuum relays 215; one or more data acquisition boards 216; or one or more breakout boards 217.

The controller module 200 can be configured with a predetermined size to accommodate the small footprint of the apparatus 100. In some cases, as illustrated in FIGS. 2A-2D, the controller module 200 can be sized with a width of about 440 millimeters (mm), a length of about 420 mm, and a depth of about 150 mm. In some cases, the controller module 200 can be sized with a width of at least about 300 mm-350 mm, 350 mm-400 mm, 400 mm-450 mm, 450 mm-500 mm, 500 mm-550 mm, 550 mm-600 mm, or greater. In some cases, the controller module 200 can be sized with a width of at most about 600 mm-550 mm, 550 mm-500 mm, 500 mm-450 mm, 450 mm-400 mm, 400 mm-350 mm, 350 mm-300 mm, or less. In some cases, the controller module 200 can be sized with a length of at least about 300 mm-350 mm, 350 mm-400 mm, 400mm-450 mm, 450 mm-500 mm, 500 mm-550 mm, 550 mm-600 mm, or greater. In some cases, the controller module 200 can be sized with a length of at most about 600 mm-550 mm, 550 mm-500 mm, 500 mm-450 mm, 450 mm-400 mm, 400 mm-350 mm, 350 mm-300 mm, or less. In some cases, the controller module 200 can be sized with a depth of at least about 50 mm - 100 mm, 100 mm-150 mm, 150 mm-200 mm, 200 mm-250 mm or greater. In some cases, the controller module 200 can be sized with a depth of at most about 250 mm-200, 200 mm-150mm, 150 mm-100 mm, 100 mm-50 mm, or less.

In some cases, the controller module 200 can be completely or partially housed in an enclosure, e.g., a sheet metal box. In some cases, the controller module 200 can be configured with different connectors (e.g., power, signal, or communication connectors), one or more power supplies, and a motor controller unit. For example, the controller module 200 can be configured to receive power, e.g., 100-240 VAC/50-60 Hz. The power may be at least about 250 watts (W), 500 W, 750 W, or more. The power may be at most about 750 W, 500 W, 250 W, or less. For example, the controller module 200 can be configured to convert power or provide power to other modules. The power may be converted to internal BUS voltage of about 48 volts direct current (VDC) or externally inputted 24 VDC emergency off (EMO) control. For example, the controller module 200 can be configured for communication via high speed ethernet communications 10/100, BiSS-C encoder communications, quadrature encoder communications, wi-fi communications, Bluetooth communications, and the like. In some cases, BiSS-C encoder communications can be used for any one or all of the direct drive motors, e.g., direct drive motors along axis A 413, axis B 414, and axis C 415. In some cases, quadrature encoder communications can be used for the motor of the Z module 300.

In some cases, the controller module 200 can be configured with other electronic components such as relays, fuses, and inductance boards to provide electrical functions of the robot apparatus 100. In some cases, the controller module 200 can be designed and constructed to be easily replicable and interchangeable for any connected robot regardless of the configuration.

In some embodiments, the controller module 200 further comprises a power module configured to supply power for operating the apparatus 100. In some embodiments, the controller module 200 further comprises a communications module configured to generate control signals for operating the apparatus 100. In some embodiments, the controller module 200 further comprises a motor controller module configured to control the motor module 400 or the motor of the Z module 300. In some embodiments, the controller module 200 further comprises a software module 250 configured to provide power signals, communication signals, or control signals to collectively operate the apparatus 100. In some embodiments, the motor module 400 is controlled by the controller module 200 to collectively operate the first, the second, and the third direct drive motors to effect transferring the sample along a learned motion path between one or more learned positions.

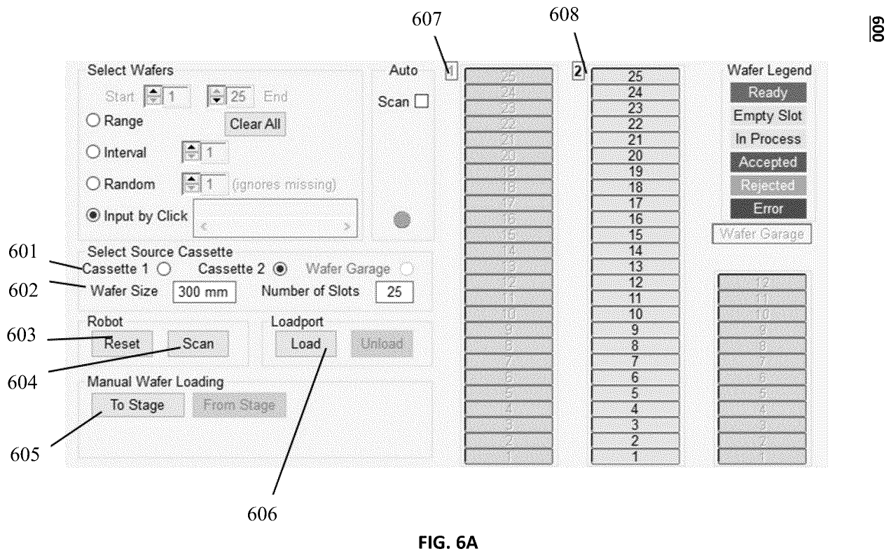

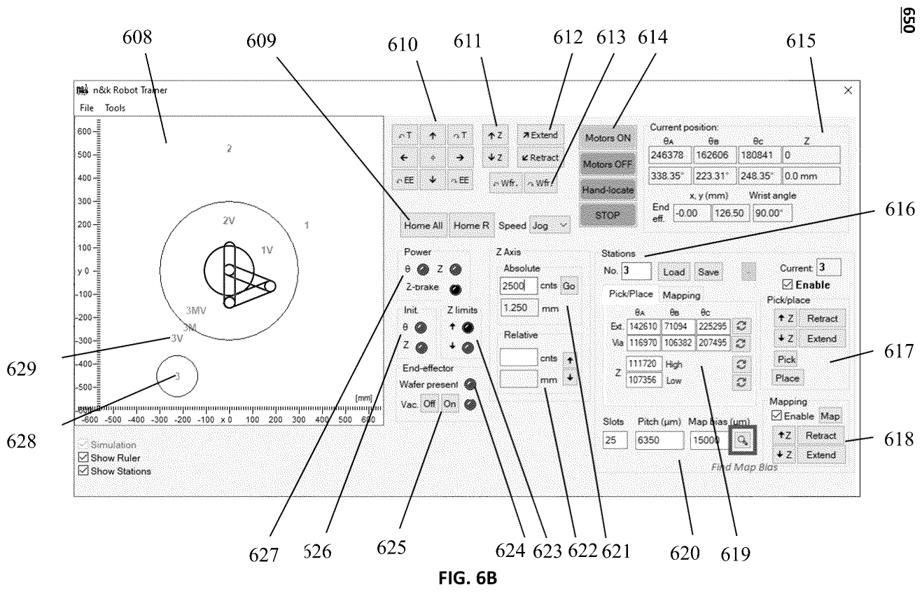

The robot apparatus 100 can be configured with a software module 250 including a graphical user interface 600 (GUI) for operating the robot apparatus 100. FIG. 6A illustrates a user interface, e.g., a graphical user interface 600 (GUI) of the software module 250, for operating the apparatus 100. In some cases, the GUI can be configured to include: selecting a cassette 601; selecting a wafer size input 602; providing a reset command 603 (e.g., performing a homing and calibration sequence); scanning a wafer 604 (e.g., detecting all wafers in a cassette); providing one or more commands to move a wafer from a cassette to a stage 605; providing one or more commands to load a wafer 606; displaying one or more slot indicators for a cassette 1 607; or displaying one or more slot indicators for a cassette 2 608.

In some embodiments, the software module 250 is further configured to determine or affect a change in an orientation of the sample, based at least on the one or more learned positions or the one or more learned motion paths. In some embodiments, the change in orientation comprises a smooth change between one or more intermediate orientations to the orientation of the sample.

The robot apparatus 100 can be configured with a software module 250 including a graphical user interface 650 (GUI) for training the robot apparatus 100. FIG. 6B illustrates a user interface, e.g., a graphical user interface 650 (GUI) of the software module 250, for training the apparatus 100 of the software module 250. In some cases, the GUI can be configured to include: a real-time graphical positional display 608; one or more home commands 609; a joystick 610 (e.g., cartesian joystick); a joystick 611 (e.g., Z joystick); a joystick 612 (e.g., extension joystick); a joystick 613 (e.g., rotation about a sample); a motor power control 614; a real-time numerical positional display 615; one or more station selectors 616; one or more pick and place commands for trained stations 617; one or more manual mapping commands 618; information for one or more stations 619 (e.g., positions can be updated and saved while jogging; one or more mapping variable inputs 620; one or more Z go-to commands 621 (e.g., absolute position); one or more Z go-to commands 622 (e.g., relative position); a Z limit status 623; a wafer presence status 624; a vacuum toggle and status 625; one or more motor initialization indicators 626; one or more motor and brake power indicators 627; a trained station 628; or a trained station via point 629.

In some embodiments, the software module 250 is further configured to provide training of the apparatus 100. In some embodiments, the training comprises generating one or more learned positions of the apparatus 100 and generating one or more learned motion paths of the apparatus 100 between the one or more learned positions. In some embodiments, the software module 250 comprises a virtual joystick and graphical user interface 650 (GUI) configured to allow a user to manually control the apparatus 100 to one or more positions along one or more motion paths.

The robot apparatus 100 can be configured with a software module 250 including a graphical user interface 650 (GUI) for troubleshooting the robot apparatus 100. In some embodiments, the software module 250 is further configured to provide troubleshooting of the apparatus 100. In some embodiments, the troubleshooting comprises testing functionality of the Z module 300. In some embodiments, the troubleshooting comprises testing functionality of the motor module 400. In some embodiments, the troubleshooting comprises testing functionality of the arm module 500. In some embodiments, the troubleshooting comprises brake toggling. In some embodiments, the troubleshooting comprises toggling of one or more peripherals. In some embodiments, the troubleshooting comprises displaying the one or more learned positions. In some embodiments, the troubleshooting comprises displaying the one or more learned motion paths. In some embodiments, the troubleshooting comprises moving the apparatus 100 between any learned positions by any learned motion paths.

The robot apparatus 100 can be configured with a software module 250 including a graphical user interface 650 (GUI) for performing wafer mapping functions. In some embodiments, the software module 250 is further configured to execute a wafer mapping function. In some embodiments, the wafer mapping function comprises positioning a wafer presence scanner 509 proximate to a wafer cassette. In some embodiments, the wafer mapping function comprises scanning along one or more dimensions of the wafer cassette. In some embodiments, the wafer mapping function comprises detecting a presence of one or more wafers in the wafer cassette. In some embodiments, the wafer mapping function comprises determining one or more problems associated with the one or more wafers. In some embodiments, the one or more problems comprises (i) one of the wafers oriented at an incorrect angle relative to a wafer slot of the wafer cassette. In some embodiments, the one or more problems comprises (ii) two or more wafers occupying the wafer slot. In some embodiments, the one or more problems comprises (iii) any combination of (i) or (ii). In some embodiments, the one or more end interchangeable effectors comprises the wafer presence scanner 509.

In some cases, the software module 250 can be installed on an external computing device and communicate (e.g., send or receive control commands) with the apparatus 100 via an application programming interface (API). Controlling the apparatus 100 via an API can minimize communication overhead and can open provide for more control operations. For example, additional control can include: testing functionality of the Z module 300, testing functionality of the motor module 400, testing functionality of the arm module 500, brake toggling, toggling of one or more peripherals, displaying the one or more learned positions, displaying the one or more learned motion paths, or moving the apparatus 100 between any learned positions by any learned motion paths.

### Framing

In some embodiments, the apparatus 100 further comprises a first frame configured to enclose the Z module 300 and the motor module 400 in a central portion of the first frame. In some embodiments, the apparatus 100 further comprises a second frame configured to mount the controller module 200 to the apparatus 100. In some embodiments, the second frame comprises a sheet metal box for enclosing the controller module 200. In some embodiments, the apparatus 100 further comprises one or more covers for the first and second frames configured to provide safe operation for a user. In some embodiments, each of the first, the second, and the third direct drive

### Computing Systems

In another aspect, disclosed herein is a computer program product for transferring a sample by the apparatus 100, the computer program product comprising at least one non-transitory computer-readable medium having computer-readable program code portions embodied therein, the computer-readable program code portions comprising: an executable portion configured to transfer the sample along a vertical axis by a Z module 300; an executable portion configured to independently operate one or more arms of the apparatus 100 by a motor module 400; an executable portion configured to transfer the sample along one or more horizontal axes orthogonal to the vertical axis by an arm module 500; an executable portion configured to configured to releasably hold the sample by one or more interchangeable end effectors 700 or 800; and an executable portion configured to configured to control the Z module 300, the motor module 400, the arm module 500, and the one or more interchangeable end effectors 700 or 800 by a controller module 200.

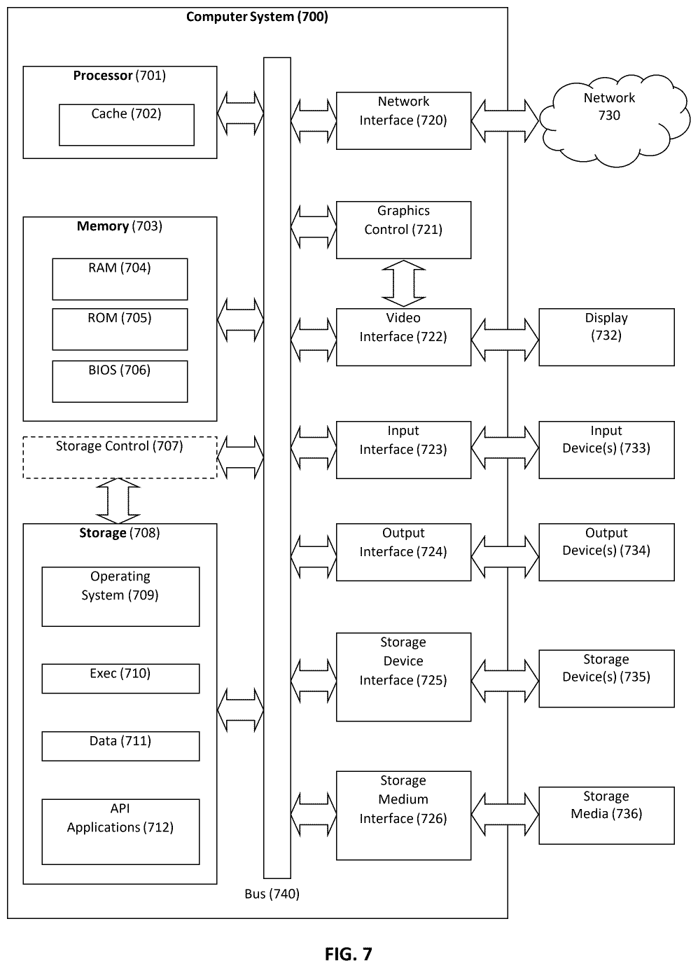

Referring to FIG. 7, a block diagram is shown depicting an exemplary machine that includes a computer system 700 (e.g., a processing or computing system) within which a set of instructions can execute for causing a device to perform or execute any one or more of the aspects and/or methodologies of the present disclosure. The components in FIG. 7 are examples only and do not limit the scope of use or functionality of any hardware, software, embedded logic component, or a combination of two or more such components implementing particular embodiments.

Computer system 700 may include one or more processors 701, a memory 703, and a storage 708 that communicate with each other, and with other components, via a bus 740. The bus 740 may also link a display 732, one or more input devices 733 (which may, for example, include a keypad, a keyboard, a mouse, a stylus, etc.), one or more output devices 734, one or more storage devices 735, and various tangible storage media 736. All of these elements may interface directly or via one or more interfaces or adaptors to the bus 740. For instance, the various tangible storage media 736 can interface with the bus 740 via storage medium interface 726. Computer system 700 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 700 includes one or more processor(s) 701 (e.g., central processing units (CPUs) or general purpose graphics processing units (GPGPUs)) that carry out functions. Processor(s) 701 optionally contains a cache memory unit 702 for temporary local storage of instructions, data, or computer addresses. Processor(s) 701 are configured to assist in execution of computer readable instructions. Computer system 700 may provide functionality for the components depicted in FIG. 7 as a result of the processor(s) 701 executing non-transitory, processor-executable instructions embodied in one or more tangible computer-readable storage media, such as memory 703, storage 708, storage devices 735, and/or storage medium 736. The computer-readable media may store software that implements particular embodiments, and processor(s) 701 may execute the software. Memory 703 may read the software from one or more other computer-readable media (such as mass storage device(s) 735, 736) or from one or more other sources through a suitable interface, such as network interface 720. The software may cause processor(s) 701 to carry out one or more processes or one or more steps of one or more processes described or illustrated herein. Carrying out such processes or steps may include defining data structures stored in memory 703 and modifying the data structures as directed by the software.

The memory 703 may include various components (e.g., machine readable media) including, but not limited to, a random access memory component (e.g., RAM 704) (e.g., static RAM (SRAM), dynamic RAM (DRAM), ferroelectric random access memory (FRAM), phase-change random access memory (PRAM), etc.), a read-only memory component (e.g., ROM 705), and any combinations thereof. ROM 705 may act to communicate data and instructions unidirectionally to processor(s) 701, and RAM 704 may act to communicate data and instructions bidirectionally with processor(s) 701. ROM 705 and RAM 704 may include any suitable tangible computer-readable media described below. In one example, a basic input/output system 706 (BIOS), including basic routines that help to transfer information between elements within computer system 700, such as during start-up, may be stored in the memory 703.

Fixed storage 708 is connected bidirectionally to processor(s) 701, optionally through storage control unit 707. Fixed storage 708 provides additional data storage capacity and may also include any suitable tangible computer-readable media described herein. Storage 708 may be used to store operating system 709, executable(s) 710, data 711, applications 712 (application programs), and the like. Storage 708 can also include an optical disk drive, a solid-state memory device (e.g., flash-based systems), or a combination of any of the above. Information in storage 708 may, in appropriate cases, be incorporated as virtual memory in memory 703.

In one example, storage device(s) 735 may be removably interfaced with computer system 700 (e.g., via an external port connector (not shown)) via a storage device interface 725. Particularly, storage device(s) 735 and an associated machine-readable medium may provide non-volatile and/or volatile storage of machine-readable instructions, data structures, program modules, and/or other data for the computer system 700. In one example, software may reside, completely or partially, within a machine-readable medium on storage device(s) 735. In another example, software may reside, completely or partially, within processor(s) 701.

Bus 740 connects a wide variety of subsystems. Herein, reference to a bus may encompass one or more digital signal lines serving a common function, where appropriate. Bus 740 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 700 may also include an input device 733. In one example, a user of computer system 700 may enter commands and/or other information into computer system 700 via input device(s) 733. Examples of an input device(s) 733 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect®, Leap Motion®, or the like. Input device(s) 733 may be interfaced to bus 740 via any of a variety of input interfaces 723 (e.g., input interface 723) including, but not limited to, serial, parallel, game port, USB, FIREWIRE, THUNDERBOLT, or any combination of the above.

In particular embodiments, when computer system 700 is connected to network 730, computer system 700 may communicate with other devices, specifically mobile devices and enterprise systems, distributed computing systems, cloud storage systems, cloud computing systems, and the like, connected to network 730. Communications to and from computer system 700 may be sent through network interface 720. For example, network interface 720 may receive incoming communications (such as requests or responses from other devices) in the form of one or more packets (such as Internet Protocol (IP) packets) from network 730, and computer system 700 may store the incoming communications in memory 703 for processing. Computer system 700 may similarly store outgoing communications (such as requests or responses to other devices) in the form of one or more packets in memory 703 and communicated to network 730 from network interface 720. Processor(s) 701 may access these communication packets stored in memory 703 for processing.

Examples of the network interface 720 include, but are not limited to, a network interface card, a modem, and any combination thereof. Examples of a network 730 or network segment 730 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 730, may employ a wired and/or a wireless mode of communication. In general, any network topology may be used.

Information and data can be displayed through a display 732. Examples of a display 732 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 732 can interface to the processor(s) 701, memory 703, and fixed storage 708, as well as other devices, such as input device(s) 733, via the bus 740. The display 732 is linked to the bus 740 via a video interface 722, and transport of data between the display 732 and the bus 740 can be controlled via the graphics control 721. In some embodiments, the display is a video projector. In some embodiments, the display is a head-mounted display (HMD) such as a VR headset. In further embodiments, suitable VR headsets include, by way of non-limiting examples, HTC Vive®, Oculus Rift®, Samsung Gear VR®, Microsoft HoloLens®, Razer OSVR®, FOVE VR®, Zeiss VR One, Avegant Glyph®, Freefly VR® headset, and the like. In still further embodiments, the display is a combination of devices such as those disclosed herein.

In addition to a display 732, computer system 700 may include one or more other peripheral output devices 734 including, but not limited to, an audio speaker, a printer, a storage device, and any combinations thereof. Such peripheral output devices may be connected to the bus 740 via an output interface 724. Examples of an output interface 724 include, but are not limited to, a serial port, a parallel connection, a USB port, a FIREWIRE port, a THUNDERBOLT port, and any combinations thereof.

In addition or as an alternative, computer system 700 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Select televisions, video players, and digital music players with optional computer network connectivity are suitable for use in the system described herein. Suitable tablet computers, in various embodiments, include those with booklet, slate, and convertible configurations.

In some embodiments, the computing device includes an operating system configured to perform executable instructions. The operating system is, for example, software, including programs and data, which manages the device's hardware and provides services for execution of applications. Suitable server operating systems include, by way of non-limiting examples, FreeBSD®, OpenBSD®, NetBSD®, Linux®, Apple® Mac OS X Server®, Oracle Solaris®, Windows Server®, and Novell NetWare®. Suitable personal computer operating systems include, by way of non-limiting examples, Microsoft Windows®, Apple Mac® OS X, UNIX®, and UNIX-like operating systems such as GNU/Linux®. In some embodiments, the operating system is provided by cloud computing. Suitable mobile smartphone operating systems include, by way of non-limiting examples, Nokia Symbian® OS, Apple® iOS, Research In Motion BlackBerry® OS, Google® Android®, Microsoft Windows Phone® OS, Microsoft Windows Mobile OS, Linux®, and Palm® WebOS. Suitable media streaming device operating systems include, by way of non-limiting examples, Apple TV®, Roku®, Boxee®, Google TV®, Google Chromecast®, Amazon Fire®, and Samsung® HomeSync®. Suitable video game console operating systems include, by way of non-limiting examples, Sony® PS3®, Sony® PS4®, Microsoft Xbox 360®, Microsoft Xbox One®, Nintendo Wii®, Nintendo Wii U®, and Ouya®. Suitable virtual reality headset systems include, by way of non-limiting example, Meta Oculus®.

### Non-Transitory Computer Readable Storage Mediums

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Programs

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Applications

In some embodiments, a computer program includes a web application. In light of the disclosure provided herein, a web application, in various embodiments, utilizes one or more software frameworks and one or more database systems. In some embodiments, a web application is created upon a software framework such as Microsoft®.NET or Ruby on Rails® (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® structured query language (SQL) Server, mySQL™, and Oracle®. A web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML® (AJAX), Flash Actionscript, Javascript®, or Silverlight®. In some embodiments, a web application is written to some extent in a server-side coding language such as Active Server Pages® (ASP), ColdFusion®, Perl®, Java®, JavaServer Pages® (JSP), Hypertext Preprocessor® (PHP), Python®, Ruby®, Tcl®, Smalltalk®, WebDNA®, or Groovy®. In some embodiments, a web application is written to some extent in a database query language such as Structured Query Language (SQL). In some embodiments, a web application integrates enterprise server products such as IBM Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft Silverlight®, Java®, and Unity®.

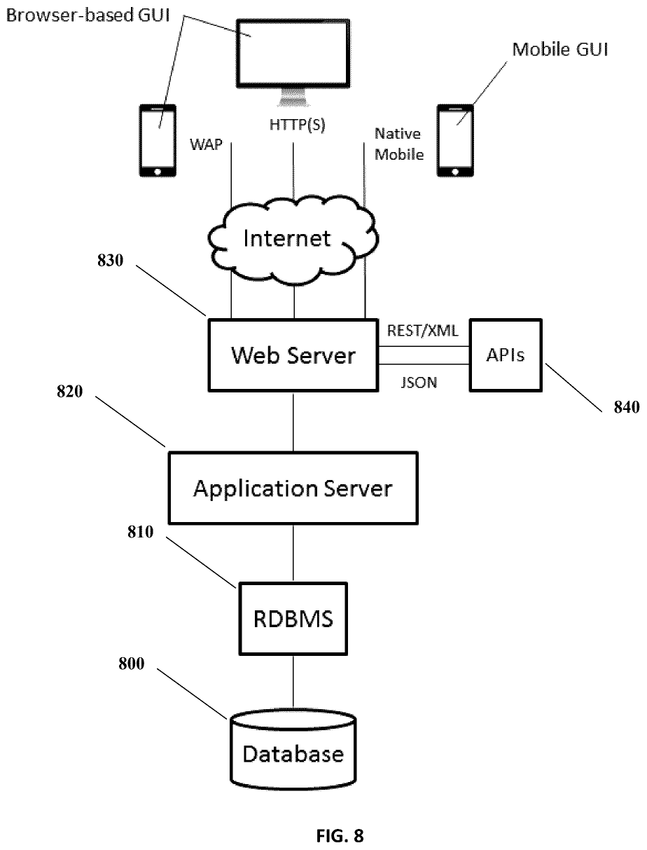

Referring to FIG. 8, in a particular embodiment, an application provision system comprises one or more databases 800 accessed by a relational database management system (RDBMS) 810. Suitable RDBMSs include Firebird®, MySQL®, PostgreSQL®, SQLite®, Oracle Database®, Microsoft SQL Server®, IBM DB2®, IBM Informix®, SAP Sybase®, SAP Sybase®, Teradata®, PostGIS®, time-series databases, graph databases, and the like. In this embodiment, the application provision system further comprises one or more application severs 820 (such as Java® servers. .NET® servers, PHP® servers, and the like) and one or more web servers 830 (such as Apache®, IIS®, GWS® and the like). The web server(s) optionally expose one or more web services via app application programming interfaces (APIs) 840. Via a network, such as the Internet, the system provides browser-based and/or mobile native user interfaces.

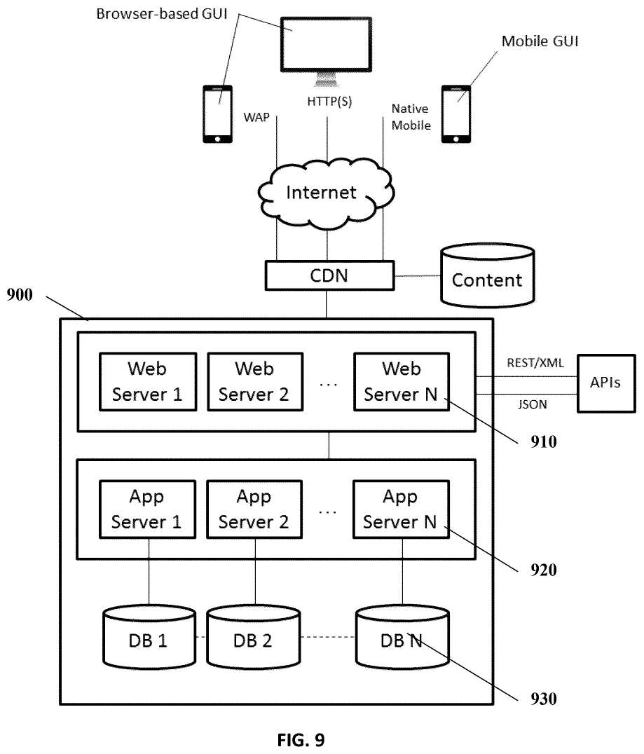

Referring to FIG. 9, in a particular embodiment, an application provision system alternatively has a distributed, cloud-based architecture 900 and comprises elastically load balanced, auto-scaling web server resources 910 and application server resources 920 as well synchronously replicated databases 930.

### Mobile Applications

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques using hardware, languages, and development environments. Mobile applications are written in several languages. Suitable programming languages include, by way of non-limiting examples, C, C++, C#, Objective-C, Java®, Javascript®, Pascal®, Object Pascal®, Python®, Ruby®, VB.NET®, WML®, and XHTML/HTML with or without CSS, or combinations thereof.

Suitable mobile application development environments are available from several sources. Commercially available development environments include, by way of non-limiting examples, AirplaySDK®, alcheMo®, Appcelerator®, Celsius®, Bedrock®, Flash Lite®, .NET Compact Framework®, Rhomobile®, and WorkLight Mobile Platform®. Other development environments are available without cost including, by way of non-limiting examples, Lazarus®, MobiFlex®, MoSync®, and Phonegap®. Also, mobile device manufacturers distribute software developer kits including, by way of non-limiting examples, iPhone® and iPad® (iOS) SDK, Android® SDK, BlackBerry® SDK, BREW SDK, Palm® OS SDK, Symbian® SDK, webOS® SDK, and Windows® Mobile SDK.

Several commercial forums are available for distribution of mobile applications including, by way of non-limiting examples, Apple®p9 App Store, Google® Play, Chrome® WebStore, BlackBerry® App World, App Store® for Palm devices, App Catalog® for webOS, Windows® Marketplace for Mobile, Ovi Store for Nokia® devices, Samsung® Apps, and Nintendo® DSi Shop.

### Standalone Applications

In some embodiments, a computer program includes a standalone application, which is a program that is run as an independent computer process, not an add-on to an existing process, e.g., not a plug-in. Standalone applications are often compiled. A compiler is a computer program(s) that transforms source code written in a programming language into binary object code such as assembly language or machine code. Suitable compiled programming languages include, by way of non-limiting examples, C, C++, Objective-C®, COBOL®, Delphi, Eiffel®, Java®, Lisp®, Python®, Visual Basic®, and VB.NET®, or combinations thereof. Compilation is often performed, at least in part, to create an executable program. In some embodiments, a computer program includes one or more executable compiled applications. Additionally, microservices related to Python® and JavaScript® may be used.

### Web Browser Plug-Ins

In some embodiments, the computer program includes a web browser plug-in (e.g., web extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Several web browser plug-ins may include Adobe Flash Player®, Microsoft Silverlight®, and Apple QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, several plug-in frameworks are available that enable development of plug-ins in various programming languages, including, by way of non-limiting examples, C++, Delphi®, Java, PHP®, Python®, and VB.NET®, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft Internet Explorer®, Mozilla Firefox®, Google Chrome®, Apple Safari®, Opera Software Opera®, and KDE Konqueror®. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google Android® browser, RIM BlackBerry® Browser, Apple Safari®, Palm Blazer®, Palm WebOS® Browser, Mozilla Firefox® for mobile, Microsoft Internet Explorer Mobile®, Amazon Kindle Basic Web®, Nokia Browser®, Opera Software Opera Mobile®, and Sony PSP® browser.

### Software Modules

In some embodiments, the platforms, systems, media, and methods disclosed herein include software, server, and/or database modules, or use of the same. In view of the disclosure provided herein, software modules are created by techniques using machines, software, and languages. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases (DB), or use of the same. In view of the disclosure provided herein, many databases are suitable for storage and retrieval data. In various embodiments, suitable databases include, by way of non-limiting examples, relational databases, non-relational databases, object oriented databases, object databases, entity-relationship model databases, associative databases, XML databases, time-series databases, graph databases, and the like. Further non-limiting examples include SQL, PostgreSQL®, MySQL®, Oracle®, DB2®, and Sybase. In some embodiments, a database is internet-based. In further embodiments, a database is web-based. In still further embodiments, a database is cloud computing-based. In a particular embodiment, a database is a distributed database. In other embodiments, a database is based on one or more local computer storage devices.

### EXAMPLES

The following illustrative examples are representative of embodiments of systems and methods described herein and are not meant to be limiting in any way.

### Example 1

### Advantages and Improvements When Using Direct Drive Motors of Same Size and Type

Use of direct drive motors of the same type and size can provide advantages and improvements over a robot apparatus that uses motors of different types or sizes. For example, use of direct drive motors of the same size and type can simplify sourcing or procurement requirements in the supply chain. For example, use of direct drive motors of the same size and type can simplify mounting hardware requirements because hardware, e.g., clamping rings, can be re-used in multiple locations throughout the robot apparatus. For example, use of direct drive motors of the same size and type can simplify quality control of parts due to a smaller number of different types of parts in use for the robot apparatus. For example, use of direct drive motors of the same size and type can simplify testing of the direct drive motors. One simple fixture can be used for testing all of the direct drive motors rather than having numerous and complex fixtures for testing different sizes or types of motors. For example, use of direct drive motors of the same size and type can simplify workflows for users. Because the direct drive motors are of the same size and type, users are less likely to be make errors when checking the specifications for each direct drive motor against actual motor performance. This can also help to simplify motor tuning procedures because the motors share specifications and common starting points.

### Example 2

### Advantages and Improvements When Using Cross Roller Bearings

Use of cross roller bearings can provide advantages and improvements over a robot apparatus that uses other types of bearings, e.g., comparably sized angular, 4 point contact bearings. For example, use of cross roller bearings can increase stiffness compared to other bearings resulting in fewer failure modes. For example, use of cross roller bearings can increase the supported moment load compared to other bearings. For example, use of cross roller bearings can provide for easier installation because the cross roller bearings can be face mounted without difficult alignment procedures that may be used for other bearings. Also, a pre-load of cross roller bearings can be set at the bearing factory rather than set during installation using shaft or housing sizing or springs. For example, use of cross roller bearings can simplify or reduce machining tolerances because the cross roller bearings can be face mounted rather than mounted with tight tolerances via pressing, clamping, and the like into the bearing's receiving hole or aperture. For example, use of cross roller bearings can reduce the number of parts required because a simple plate with taps can be used for mounting the cross roller bearings rather than using additional parts such as clamping rings, springs, and the like.

### Terms and Definitions

Unless otherwise defined, all technical terms used herein have the same meaning as commonly understood by one of ordinary skill in the art to which this present disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C”, “one or more of A, B, or C” and “A, B, and/or C” means A alone, B alone, C alone, A and B together, A and C together, B and C together, or A, B and C together.

While preferred embodiments of the present disclosure have been shown and described herein, such embodiments are provided by way of example only. It is not intended that the present disclosure be limited by the specific examples provided within the specification. While the present disclosure has been described with reference to the aforementioned specification, the descriptions and illustrations of the embodiments herein are not meant to be construed in a limiting sense. Numerous variations, changes, and substitutions may occur without departing from the present disclosure. Furthermore, it shall be understood that all aspects of the present disclosure are not limited to the specific depictions, configurations, or relative proportions set forth herein which depend upon a variety of conditions and variables. It should be understood that various alternatives to the embodiments of the present disclosure described herein may be employed in practicing the present disclosure. It is therefore contemplated that the present disclosure shall also cover any such alternatives, modifications, variations, or equivalents. It is intended that the following claims define the scope of the present disclosure and that systems, methods and structures within the scope of these claims and their equivalents be covered thereby.

What is claimed is:

1. An apparatus for transferring a sample, the apparatus comprising:
a Z module configured to transfer the sample along a vertical axis;
a motor module operatively coupled to the Z module and configured to independently operate one or more arms of the apparatus;
an arm module comprising the one or more arms operatively coupled to the motor module and configured to transfer the sample along one or more horizontal axes orthogonal to the vertical axis;
one or more interchangeable end effectors operatively coupled to the arm module and configured to releasably hold the sample; and
a controller module configured to control the Z module, the motor module, the arm module, and the one or more interchangeable end effectors for transferring the sample,
wherein the Z module, the motor module, or the arm module is configured to be interchangeable with another module.

2. The apparatus of claim 1, wherein the Z module further comprises:
a motor;
a ball screw operatively coupled to the motor;
a rail and carriage operatively coupled to the ball screw via a nut; and
a platform configured to mount the motor module,
wherein collective operation of the motor, the ball screw, the rail and carriage, and the nut by the Z module is configured to transfer the sample along the vertical axis.

3. The apparatus of claim 1, wherein the motor module further comprises:
a first direct drive motor configured to operate the one or more arms;
a second direct drive motor configured to operate the one or more arms; and
a third direct drive motor configured to operate the one or more arms,
wherein collective operation of the first, the second, and the third direct drive motors is configured to transfer the sample along any axis of the one or more horizontal axes.

4. The apparatus of claim 3, wherein each of the first, the second, and the third direct drive motors is positioned in a central portion of a frame of the apparatus.

5. The apparatus of claim 3, wherein each of the first, the second, and the third direct drive motors is arranged concentrically with each of the other direct drive motors.

6. The apparatus of claim 3, wherein each of the first, the second, and the third direct drive motors is arranged above or below each of the other direct drive motors.

7. The apparatus of claim 3, wherein the motor module further comprises:
a first shaft operatively coupled to and concentrically aligned inside the first direct drive motor and configured to transmit a mechanical force to the one or more arms via one or more cross roller bearings;
a second shaft operatively coupled to and concentrically aligned inside of the second direct drive motor and configured to transmit a mechanical force to the one or more arms arm via one or more pulleys and one or more timing belts; and
a third shaft operatively coupled to and concentrically aligned inside of the third direct drive motor and configured to transmit a mechanical force to the one or more arms arm via one or more pulleys and one or more timing belts,
wherein collective operation of the first, the second, and the third shafts by the motor module is configured to transfer the sample along any axis of the one or more horizontal axes.

8. The apparatus of claim 7, wherein the second shaft is concentrically aligned inside the first shaft and wherein the third shaft is concentrically aligned inside the second shaft.

9. The apparatus of claim 7, wherein the motor module further comprises a conduit configured to:
carry one or more control signal wires from the controller module to the arm module or the motor module; and
carry a vacuum line from a vacuum source to the one or more interchangeable end effectors via the arm module.

10. The apparatus of claim 9, wherein the conduit is concentrically aligned inside of the third shaft and is attached to a first arm of the one or more arms.

11. The apparatus of claim 3, wherein the motor module is controlled by the controller module to collectively operate the first, the second, and the third direct drive motors to effect transferring the sample along a learned motion path between one or more learned positions.

12. The apparatus of claim 1, wherein the arm module further comprises:
a first arm of the one or more arms operatively coupled to a first cross roller bearing of the motor module and configured with a second cross roller bearing associated with a first set of one or more shafts, one or more pulleys, one or more timing belts, one or more concentric steel plates, or one or more stops;
a second arm of the one or more arms operatively coupled to the second cross roller bearing of the first arm and configured with a third cross roller bearing associated with a second set of one or more shafts, one or more pulleys, one or more timing belts, one or more concentric steel plates, or one or more stops; and
a third arm of the one or more arms operatively coupled to the third cross roller bearing of the second arm, wherein the third arm is configured to releasably hold the one or more interchangeable end effectors,
wherein collective operation of the first, the second, and the third arms by the arm module is configured to transfer the sample along any axis of the one or more horizontal axes.

13. The apparatus of claim 1, wherein each of the one or more arms of the arm module do not comprise an integrated motor.

14. The apparatus of claim 1, wherein each of the one or more arms of the arm module comprises a three-joint arm module.

15. The apparatus of claim 1, wherein the one or more interchangeable end effectors comprises a first end effector configured to releasably hold a wafer.

16. The apparatus of claim 15, wherein the first end effector is further configured to:
operatively couple to a vacuum for releasably holding the wafer; and
operatively couple to a sensor for determining a presence of the wafer, wherein the sensor comprises a vacuum sensor.

17. The apparatus of claim 1, wherein the one or more interchangeable end effectors comprises a second end effector configured to releasably hold a photomask.

18. The apparatus of claim 17, wherein the second end effector is further configured to:
operatively use one or more pads for contacting the photomask along one or more edges of the photomask; and
operatively couple to a sensor for determining a presence of the photomask, wherein the sensor comprises a limited reflected fiber unit.

19. The apparatus of claim 1, wherein the controller module further comprises:
a power module configured to supply power for operating the apparatus;
a communications module configured to generate control signals for operating the apparatus;
a motor controller module configured to control the motor module or the motor of the Z module; and
a software module configured to provide power signals, communication signals, or control signals to collectively operate the apparatus.

20. The apparatus of claim 19, wherein the software module is further configured to provide training of the apparatus, wherein the training comprises generating one or more learned positions of the apparatus and generating one or more learned motion paths of the apparatus between the one or more learned positions.

21. The apparatus of claim 20, wherein the software module is further configured to determine or affect a change in an orientation of the sample, based at least on the one or more learned positions or the one or more learned motion paths, wherein the change in orientation comprises a smooth change between one or more intermediate orientations to the orientation of the sample.

22. The apparatus of claim 20, wherein the software module is further configured to provide troubleshooting of the apparatus, wherein the troubleshooting comprises testing functionality of the Z module, testing functionality of the motor module, testing functionality of the arm module, brake toggling, toggling of one or more peripherals, displaying the one or more learned positions, displaying the one or more learned motion paths, or moving the apparatus between any learned positions by any learned motion paths.

23. The apparatus of claim 20, wherein the software module is further configured to execute a wafer mapping function comprising:
positioning a wafer presence scanner proximate to a wafer cassette;
scanning along one or more dimensions of the wafer cassette;
detecting a presence of one or more wafers in the wafer cassette; and
determining one or more problems associated with the one or more wafers,
wherein the one or more problems comprises (i) one of the wafers oriented at an incorrect angle relative to a wafer slot of the wafer cassette, (ii) two or more wafers occupying the wafer slot, or (iii) any combination of (i) or (ii),
wherein the one or more end interchangeable effectors comprises the wafer presence scanner.

24. The apparatus of claim 20, wherein the software module comprises a virtual joystick and graphical user interface (GUI).

25. The apparatus of claim 24, wherein the one or more motion paths comprise (i) one or more arbitrary motion paths, (ii) the one or more learned motion paths, or (iii) a combination of (i) or (ii).

26. The apparatus of claim 1, wherein the apparatus is configured to rotate the sample relative to the apparatus during transferring of the sample or during a stationary position of the sample.

27. The apparatus of claim 1, wherein the apparatus is configured to maintain a fixed orientation of the sample relative to the apparatus during transferring of the sample or during a stationary position of the sample to avoid one or more collisions of the sample.

28. The apparatus of claim 1, wherein the vertical axis and the one or more horizontal axes are not aligned to the center of the apparatus.

29. The apparatus of claim 1, further comprising:
a first frame configured to enclose the Z module and the motor module in a central portion of the first frame;
a second frame configured to mount the controller module to the apparatus, wherein the second frame comprises a sheet metal box for enclosing the controller module; and
one or more covers for the first and second frames configured to provide safe operation for a user.

30. The apparatus of claim 1, wherein the Z module, the motor module, or the arm module is configured to be interchangeable with another module of the same type.

31. The apparatus of claim 1, wherein the apparatus comprises a 4-axis modular robot.

32. A computer program product for transferring a sample by an apparatus, the computer program product comprising at least one non-transitory computer-readable medium having computer-readable program code portions embodied therein, the computer-readable program code portions comprising:
an executable portion configured to transfer the sample along a vertical axis by a Z module;
an executable portion configured to independently operate one or more arms of the apparatus by a motor module;
an executable portion configured to transfer the sample along one or more horizontal axes orthogonal to the vertical axis by the one or more arms of an arm module;
an executable portion configured to configured to releasably hold the sample by one or more interchangeable end effectors; and
an executable portion configured to configured to control the Z module, the motor module, the arm module, and the one or more interchangeable end effectors by a controller module.
